(19) United States
(12) Patent Application Publication
(10) Pub. No.: US 2025/0166107 A1
(43) Pub. Date: May 22, 2025

(54) FOR-HIRE-VEHICLE MANAGEMENT SYSTEMS AND METHODS

(71) Applicant: IVSC IP LLC, Las Vegas, NV (US)

(72) Inventors: Mark Alden James, Las Vegas, NV (US); James Alan Wisniewski, Las Vegas, NV (US); Leocadio Dominquez Samson, Pleasant Hill, CA (US)

(73) Assignee: IVSC IP LLC, Las Vegas, NV (US)

(21) Appl. No.: 18/913,913

(22) Filed: Oct. 11, 2024

Related U.S. Application Data
(63) Continuation of application No. 17/706,226, filed on Mar. 28, 2022, now abandoned.
Application No. 17/706,226 is a continuation of application No. 16/565,317, filed on Sep. 9, 2019, now abandoned.
Application No. 16/565,317 is a continuation of application No. 15/345,303, filed on Nov. 7, 2016, now abandoned.
Application No. 15/345,303 is a continuation of application No. 13/627,990, filed on Sep. 26, 2012, now abandoned.
Application No. 15/345,303 is a continuation of application No. 15/055,374, filed on Feb. 26, 2016, now abandoned.
Application No. 15/055,374 is a continuation of application No. 13/627,995, filed on Sep. 26, 2012, now abandoned.
Application No. 15/345,303 is a continuation of application No. 13/627,979, filed on Sep. 26, 2012, now abandoned.
Application No. 15/345,303 is a continuation of application No. 15/185,764, filed on Jun. 17, 2016, now abandoned.
Application No. 15/185,764 is a continuation of application No. 13/627,986, filed on Sep. 26, 2012, now abandoned.
Application No. 15/345,303 is a continuation of application No. 15/131,947, filed on Apr. 18, 2016, now abandoned.
Application No. 15/131,947 is a continuation of application No. 13/627,999, filed on Sep. 26, 2012, now abandoned.
(60) Provisional application No. 61/695,269, filed on Aug. 30, 2012.
(60) Provisional application No. 61/695,269, filed on Aug. 30, 2012.
(60) Provisional application No. 61/695,269, filed on Aug. 30, 2012.
(60) Provisional application No. 61/695,269, filed on Aug. 30, 2012.
(60) Provisional application No. 61/695,269, filed on Aug. 30, 2012.

(51) Int. Cl. G06Q 50/40; G06Q 30/0283

(52) U.S. Cl. CPC G06Q 50/40; G06Q 30/0284

(57) ABSTRACT

The present disclosure relates to systems and methods for the management of for-hire vehicles such as taxis, limousines, shuttles, buses or other vehicles that provide shared transportation or transport one or more passengers between locations of the passengers' choice. The systems and methods can allow for passenger/driver mobile application integration, while also providing adequate oversight by regulatory agencies and fleet owners.

### PRIORITY INFORMATION

Any and all applications for which a foreign or domestic priority claim is identified in the Application Data Sheet as filed with the present application are hereby incorporated by reference in their entirety under 37 CFR 1.57.

### INCORPORATION BY REFERENCE

The following U.S. Patent applications are co-pending and commonly owned. These applications have the following titles, application serial numbers, filing dates, and attorney docket numbers:
FOR-HIRE VEHICLE FARE AND PARAMETER CALCULATION SYSTEM AND METHOD, application Ser. No. 15/055,374, filed Feb. 26, 2016, with attorney docket number INVSC.047C1 (now abandoned), which is a continuation of now abandoned application Ser. No. 13/627,995, filed Sep. 26, 2012;
MOBILE FOR-HIRE VEHICLE HEAILING SYSTEM AND METHOD, application Ser. No. 13/627,979, filed Sep. 26, 2012, with attorney docket number INVSC.051A (now abandoned);
FOR-HIRE-VEHICLE PARAMETER UPDATE AND MANAGEMENT SYSTEM AND METHOD, application Ser. No. 13/627,990, filed Sep. 26, 2012, with attorney docket number INVSC.052A (now abandoned);
ON BOARD DIAGNOSTIC (OBD) DEVICE SYSTEM AND METHOD, application Ser. No. 15/185,764, filed Jun. 17, 2016, with attorney docket number INVSC.053C1 (now abandoned), which is a continuation of now abandoned application Ser. No. 13/627,986, filed Sep. 26, 2012;
TRANSPORTATION CONTROL AND REGULATION SYSTEM AND METHOD FOR FOR-HIRE VEHICLES, application Ser. No. 15/131,947, filed Apr. 18, 2016, with attorney docket number INVSC.054C1 (now abandoned), which is a continuation of now abandoned application Ser. No. 13/627,999, filed Sep. 26, 2012.

All of the above referenced patent applications are hereby incorporated by reference herein in their entireties.

### BACKGROUND

The present disclosure relates to the field of for-hire vehicles such as taxis, limousines, shuttles, buses or other vehicles that provide shared transportation or transport one or more passengers between locations of the passengers' choice.

A for-hire vehicle (“FHV”) generally charges fares based on one or more variables. The variables may include the distance traveled, traveling time, the number of passengers transported by the FHV, among other things. The cost associated with each of these variables is often set by a regulatory agency that regulates the FHVs operating within its jurisdiction of control. Typically, the jurisdiction of control corresponds to a city or metro area; however, in some cases, a jurisdiction may correspond to a county, several counties, or even an entire state.

Regulatory agencies may also issue permits to operate a vehicle for hire (“medallions”), which may be affixed to the hood of an FHV, or otherwise displayed to indicate regulatory compliance. Medallions may indicate the type of license associated with the FHV and may correspond to a timeframe, such as a year, or they may permit the operation of a FHV only within a particular area within the jurisdiction of control or only during certain days and times. FHVs often include fare-calculating devices called taximeters for transactional purposes. Taximeters used to calculate and/or display taxi fares are often computer devices that are affixed to, or disposed in, a region of an FHV interior and coupled in some manner to the vehicle's on-board diagnostic system. FHV meters may be programmed by a regulatory agency that regulates the FHV to which the meter is affixed.

### BRIEF DESCRIPTION OF THE DRAWINGS

Various embodiments are depicted in the accompanying drawings for illustrative purposes, and should in no way be interpreted as limiting the scope of the inventions. In addition, various features of different disclosed embodiments can be combined to form additional embodiments, which are part of this disclosure. Throughout the drawings, reference numbers may be reused to indicate correspondence between reference elements.

FIG. 1 illustrates an embodiment of a system for managing and/or regulating taximeter operation.

FIG. 2A illustrates a block diagram representing an embodiment of an OBD device in accordance with one or more embodiments disclosed herein.

FIG. 2B illustrates a block diagram representing an embodiment of an OBD device.

FIG. 2C illustrates a top view of an embodiment of an OBD device.

FIG. 2D illustrates a perspective view of an embodiment of an OBD device.

FIG. 2E illustrates a side view of an embodiment of an OBD device.

FIG. 2F illustrates a side view of an OBD device including a pass-through connector.

FIG. 2G illustrates a bottom view of the OBD device of FIG. 2F.

FIG. 3A illustrates a block diagram representing an embodiment of a mobile computing device.

FIG. 3B illustrates a block diagram representing an embodiment of a mobile device associated with an operator of an FHV.

FIGS. 3C-3G illustrate embodiments of FHV operator device user-interfaces.

FIG. 4A illustrates a block diagram representing an embodiment of a mobile device associated with a passenger of an FHV.

FIGS. 4B-4H illustrate embodiments of passenger device user-interfaces.

FIG. 5A illustrates a block diagram representing an embodiment of a FHV management server.

FIGS. 5B-5G illustrate embodiments of server-side user-interfaces.

FIG. 6 is a flowchart illustrating an embodiment of a process for assigning fare calculation algorithms and meter parameter to an FHV trip.

FIG. 7 illustrates an embodiment of a system including a central server configured to service FHV operations in multiple jurisdictions and/or zones.

FIG. 8 is a flowchart illustrating an embodiment of a process for engaging in a passenger FHV transaction.

FIG. 9 is a flowchart illustrating an embodiment of a process for inputting regulatory parameters by a regulatory agency.

FIG. 10 is a flowchart illustrating an embodiment of a process for inputting status information by a regulatory agency.

FIG. 11 is a flowchart illustrating an embodiment of a process for inputting status information by a fleet operator.

### DESCRIPTION OF EMBODIMENTS

### Overview

The calculation of fares for a trip in a FHV may be done with the assistance of a meter. The terms ‘taximeter’ and ‘meter’ are used herein according to their broad and/ordinary meanings, and may include, without limitation, mechanical and/or electronic devices used to calculate and/or display passenger fares, among possibly other FHV-related information. Such fares may be calculated based on distance traveled and/or travel/waiting time. A meter may be programmed with certain variable values for use in fare calculations, as well as other variables set by one or more regulatory agencies. An FHV meter may be started or initiated in association with the FHV being hired for, or beginning, a trip. When the trip is concluded, certain operations of the meter may be stopped. In certain embodiments, a fare amount calculated by a meter located within the FHV, such as a dashboard, ceiling-mounted or any add-on electronic device, is displayed in real time via an electronic display that is part of the meter. In certain embodiments, fares may be calculated without the use of a meter based on time of pick up and drop off of a passenger, distance, and/or or physical location that an FHV travels through (or to/from) while transporting or otherwise providing service to a passenger. Fare calculations may also vary based on factors such as the type of vehicle being used and the nature of the event to or from which the FHV provides service (e.g., premiums may be charged for transportation to or from special events, geographic points that are subject to additional fees).

With respect to the business of operating FHVs, fraud associated with fare calculation or other aspects of meter operation may be a concern to regulatory agencies, fleet owners, or others. Therefore, in certain jurisdictions, regulatory agencies often physically seal FHV meters to prevent tampering with the meter itself, or data stored therein. For example, once a regulatory agency sets fare rates for a particular meter, the meter may then be locked with a physical seal that prevents, or shows evidence of, tampering. Once the meter is sealed, modules that are part of the meter, such as fare displays and receipt or trip sheet printers, may likewise be sealed. The process of physically sealing meters may make updating rates and other variables relatively difficult and/or time consuming to implement. For example, if a regulatory agency wishes to update rates or calculation algorithms/logic, it may be necessary for agents of the regulatory agency to physically access each meter to be updated, break the seals protecting the meters from tampering, perform the desired updates, and reseal the meter. Such a process may be quite labor and/or time-intensive, particularly with respect to regulatory agencies having jurisdiction over hundreds or thousands of FHV meters, each of which may need to be manually opened, updated and resealed. The cost associated with implementing such meter updating procedures may likewise be a consideration. Some regulatory agencies pass at least a portion of the cost of opening and resealing meters onto FHV fleet operators. Fleet operators may yet incur further costs associated with meter updating in the form of opportunity cost as a result of having to remove an FHV from the fleet for a period of time so that its meter can be updated.

Systems may be configured to provide for mobile payment of fares for FHVs using software applications, as well as mobile applications used to simulate meters. However, such activity may not be adequately overseen by relevant regulatory agencies or FHV owners, thereby potentially providing opportunity for fraud and/or operation of FHVs outside of regulatory or statutory limitations. Therefore, a system allowing for passenger/driver mobile application integration, while also providing adequate oversight by regulatory agencies and fleet owners, may be desirable.

### For-Hire Vehicle Fare and Parameter Calculation

Certain embodiments disclosed herein provide systems and methods for calculating fares for for-hire vehicle (FHV) trips. Trip data, such as time, distance, location, or other trip-related data, is received over a network from a computing device disposed within a remotely-located FHV. The trip data is used to calculate a trip fare, which is provided to the computing device over a wide area network.

Certain embodiments disclosed herein provide a for-hire vehicle (FHV) management system including a computer memory that stores fare calculation information associated with a plurality of jurisdictions and computer hardware including a processor in communication with the memory and configured to receive trip data over a network from a computing device disposed within a remotely-located FHV indicating time and/or distance associated with a trip taken by the FHV. The processor may be further configured to calculate a trip fare based at least in part on the trip data, the fare calculation information, and a location of the FHV, and provide the trip fare to the computing device over a wide area network. In certain embodiments, the processor is further configured to store the trip data in the computer memory.

The trip data may include a start time and an end time of the FHV trip, or a distance of the FHV trip. The fare calculation information may include a plurality of fare calculation algorithms, wherein the processor is configured to select an algorithm for fare calculation based at least in part on the location of the computing device or the FHV. Furthermore, the fare calculation information may include a plurality of sets of fare calculation parameter values, wherein the processor is configured to select a set of parameters based at least in part on the location of the FHV.

Certain embodiments disclosed herein provide an FHV management system including a computer memory that stores fare calculation information associated with a plurality of regulatory jurisdictions and computer hardware including a processor in communication with the memory and configured to receive first trip data over a network from a first computing device disposed within a remotely located FHV indicating time and/or distance associated with a trip taken by the FHV. The processor may be further configured to receive second trip data over a network from a second computing device disposed within the FHV indicating time and/or distance associated with the trip, calculate a trip fare based at least in part on the first trip data, the fare calculation information, and a location of the FHV, verify the correctness of the calculated trip fare based at least in part on the second trip data, and provide the trip fare to the first computing device.

The processor may be further configured to provide an error signal when there is a discrepancy between the first trip data and the second trip data. Furthermore, the processor may be configured to calculate a verification trip fare based at least in part on the second trip data, the fare calculation information, and the location of the FHV. In certain embodiments, when the trip fare and the verification trip fare are different, the processor is configured to determine an average fare of historical trips having similar starting and destination points and provide the average of the two fares to the first computing device.

The second trip data may include data generated by an on-board diagnostic system of the FHV, and may be received from a driver of the FHV. In certain embodiments, the processor is further configured to receive third trip data from a third computing device disposed within the FHV indicating time and/or distance associated with the trip.

Certain embodiments disclosed herein provide a process of calculating an FHV trip fare, the process including receiving trip data from a computing device disposed within a remotely-located FHV indicating time and/or distance associated with a trip taken by the FHV. The process may further include calculating a trip fare based at least in part on the trip data and providing the trip fare to the computing device over a wide area network. In certain embodiments, the process further includes receiving trip data from a second mobile device, and verifying that the calculated trip fare is correct based at least in part on the trip data from the second mobile device.

In certain embodiments, calculating the trip fare is performed using a fare calculation algorithm and fare calculation parameters stored in computer memory. The process may further include selecting the fare calculation algorithm from among a group of fare calculation algorithms based on a location of the computing device or the FHV. The fare calculation algorithm may include a fee associated with airport transportation when the computing device is located at an airport.

Mobile for-Hire Vehicle Hailing

Certain embodiments disclosed herein provide systems and methods for engaging a for-hire vehicle (FHV). A mobile computing device receives information from a remote server indicating FHV activity in a geographical region of interest. A user interface of the mobile computing device displays a map having one or more icons thereon indicating locations of one or more FHVs. A user provides an input indicating a desire to hail one of the one or more FHVs, and receives an acceptance of hail. Once within range of the FHV, the device links with a computing device disposed within the hailed FHV over a local area network, providing information related an FHV trip to the remote server, receiving a calculated fare, and displaying the calculated fare to the user.

Certain embodiments disclosed herein provide a computer-implemented process for engaging a for-hire vehicle. The process may include receiving, by a first mobile computing device, information from a remote server indicating FHV activity in a geographical region of interest and providing a user interface for viewing by a user seeking FHV transportation service, the user interface displaying a map having one or more icons thereon indicating locations of one or more FHVs. The process may further include receiving user input indicating a desire to hail one of the one or more FHVs, transmitting a hailing signal, receiving an acceptance of the hailing signal and notifying the user of the acceptance, linking with a second computing device disposed within the hailed FHV over a local area network, providing information related an FHV trip to the remote server, receiving a calculated fare, and displaying the calculated fare to the user.

In certain embodiments, the second computing device is a mobile computing device. The calculated fare may further be received from the remote server. The calculated fare may be based at least in part on a first set of rules when the first mobile computing device is located within a first jurisdiction and is based on a second set of rules when the first mobile computing device is located within a second jurisdiction. The user interface may display information associated with the one or more icons indicating a type of vehicle.

The process may further include providing functionality for the user to pay the calculated fare. Providing functionality for the user to pay the fare can include presenting a payment user interface, wherein the user may input payment information using the payment user interface. In certain embodiments, the user interface includes an icon indicating a current location of the user.

The process may further include linking with a third mobile computing device over a local area network, such as a mobile computing device of an FHV operator. Furthermore, the process may include receiving a signal from the third mobile device indicating the start of the FHV trip. The process may include one or more of the following steps: displaying an estimated time of arrival of the hailed FHV; displaying a distance of the hailed FHV from a current location of the user or a designated puck-up location; and providing functionality for the user to select an FHV for hailing from among a group of available FHVs.

Certain embodiments disclosed herein provide a system for managing calculated fares associated with for-hire vehicle activity. The system may include, among possibly other things, a computer memory and computer hardware including a processor in communication with the memory. In certain embodiments, the computer hardware is configured to receive information from a remote server indicating FHV activity in a geographical region of interest; provide a user interface for viewing by a user seeking FHV transportation service, the user interface displaying a map having one or more icons thereon indicating locations of one or more FHVs; receive user input indicating a desire to hail one of the one or more FHVs; transmit a hailing signal; receive an acceptance of the hailing signal and notify the user of the acceptance; link with a second mobile computing device disposed within the hailed FHV over a local area network; provide information related to an FHV trip to the remote server; receive a calculated fare; and display the calculated fare to the user.

In certain embodiments, the user interface is configured to display information associated with the one or more icons indicating a type of vehicle. Furthermore, the processor may be further configured to provide functionality for the user to pay the calculated fare. The processor may be configured to present a payment user interface to the user, wherein the user may input payment information using the payment user interface. The user interface includes an icon indicating a current location of the user.

In certain embodiments, the processor is further configured to perform one or more of the following functions: link with a third mobile computing device over a local area network; receive a signal from the third mobile device indicating the start of the FHV trip; display an estimated time of arrival of the hailed FHV; display a distance of the hailed FHV from a current location of the user; and provide functionality for the user to select an FHV for hailing from among a group of available FHVs.

### For-Hire Vehicle Parameter Update and Management

Certain embodiments disclosed herein provide systems and methods for updating and managing for-hire vehicle (FHV) fare calculation algorithms and parameters. Fare calculation and parameter information associated with a plurality of jurisdictions regulated by one or more regulatory entities is stored in a database. An authorized user may use a web-based software program to input updated fare calculation and parameter information for a jurisdiction. The updated fare calculation and parameter information is stored, and trip fares are calculated based at least partially on the updated fare calculation and where appropriate parameter information as well as trip distance and/or time information provided by a mobile computing device when the fare is related to an FHV trip taken within the jurisdiction.

Certain embodiments disclosed herein provide a system for managing fare calculations associated with for-hire vehicle activity comprising a computer memory that stores fare calculation information associated with a plurality of jurisdictions regulated by one or more regulatory entities and computer hardware including one or more processors in communication with the memory. The one or more processors may be configured to perform one or more of the following: provide a user interface for viewing by an agent of the regulatory entity, the user interface including functionality for a user to input updated fare calculation information; receive updated fare calculation information from a first remote computer, the updated fare calculation information input using the user interface; store the updated fare calculation parameter information in the memory; and calculate trip fares based at least partially on the updated fare calculation parameter information and trip distance and/or time information provided by a second remote computer.

In certain embodiments, the computer memory stores fare calculation information associated with a jurisdiction regulated by a second regulatory entity. The one or more processors may be further configured to calculate trip fares based at least partially on the fare calculation information associated with the jurisdiction regulated by the second regulatory entity. The user interface may be configured to display a map showing real-time FHV activity in at least a portion of the jurisdiction. The user interface may be further configured to display historical FHV activity.

In certain embodiments, the user interface is configured to display a list of FHV trips taken within the jurisdiction, as well as details associated with the trips. The fare calculation information may include an algorithm, wherein the processors are configured to calculate trip fares using the algorithm. The fare calculation information may include fare calculation algorithm parameter values, wherein the processors are configured to calculate trip fares using the parameter values.

The user interface may be configured to display a list of drivers who have been authorized to operate in the jurisdiction. The user interface may provide functionality for the user to search for specific trips and/or drivers associated with the jurisdiction. In certain embodiments, the user interface provides functionality for the user to modify a status of a driver to indicate that a license to operate of the driver is enabled or disabled. The user interface may further provide functionality for the user to indicate that a driver is suspended by the regulatory entity.

Certain embodiments disclosed herein provide a process of managing for-hire vehicle (FHV) fare calculations. The process may include maintaining fare calculation information associated with a jurisdiction regulated by a regulatory entity in computer memory; providing a user interface for viewing by an agent of an FHV regulatory entity, the user interface including functionality for a user to input updated fare calculation information; receiving updated fare calculation information from a first remote computer, the updated fare calculation information input using the user interface; storing the updated fare calculation parameter information in the memory; and calculating trip fares based at least partially on the updated fare calculation parameter information and trip distance and/or time information provided by a second remote computer.

The process may further include storing fare calculation information associated with a jurisdiction regulated by a second regulatory entity in the computer memory. The process may further include calculating trip fares based at least partially on the fare calculation information associated with the jurisdiction regulated by the second regulatory entity. In certain embodiments, the user interface is configured to display a map showing real-time FHV activity in at least a portion of the jurisdiction. The user interface may further be configured to display historical FHV activity. In certain embodiments, the user interface is configured to display a list of FHV trips taken within the jurisdiction, as well as details associated with the trips. The fare calculation information can include an algorithm, wherein the processors are configured to calculate trip fares using the algorithm. The fare calculation information can include fare calculation algorithm parameter values, wherein the processors are configured to calculate trip fares using the parameter values.

### On-Board Diagnostic Device

Certain embodiments disclosed herein provide systems and methods for processing and transmitting on-board diagnostics (OBD) signals. An electronic device includes a housing, an OBD engagement member configured to physically engage with an OBD port of an (FHV) and receive power and data communications therefrom. Computer circuitry disposed at least partially within the housing is configured to receive time, location, and/or distance information associated with a trip taken by the FHV, the information being received through the OBD port of the FHV. The computer circuitry is further configured to wirelessly communicate with one or more computing devices disposed within the FHV over a local area network when the on-board diagnostics device is connected to the OBD port.

Certain embodiments disclosed herein provide an on-board vehicle diagnostics device including a housing, an on-board diagnostics (OBD) engagement member configured to physically engage with an OBD port of a for-hire vehicle (FHV) and receive power and data communications therefrom, and computer circuitry disposed at least partially within the housing configured to receive time, location, and/or distance information associated with a trip taken by the vehicle, the information being received through the OBD port of the vehicle. The computer circuitry may be further configured to wirelessly communicate with one or more computing devices disposed within the FHV over a local area network when the on-board diagnostics device is connected to the OBD port.

The device may further include a GPS receiver. In certain embodiments, the GPS receiver is electrically coupled to an antenna external to the device. The device may further include an OBD signal pass-through connection port. The pass-through port can be a 16-pin female connection port. In certain embodiments, the pass-through port is configured to allow for a dedicated taximeter device to be plugged into the port. The pass-through port may provide identical signals as are provided by the OBD port of the FHV.

In certain embodiments, the computer circuitry is configured to communicate with the one or more external computing devices over a BLUETOOTH or Wi-Fi connection. The computer circuitry may be configured to transmit odometer information to the one or more external computing devices. Furthermore, the one or more external computing devices may be smartphones.

The device may further include an electrical cord connecting the OBD engagement member to the housing. In certain embodiments, the computer circuitry is configured to wirelessly communicate with the one or more computing devices automatically.

Certain embodiments disclosed herein provide a computer-implemented process of communicating vehicle diagnostics information. The process may include receiving odometer, time, and/or location information from an on-board diagnostics (OBD) system of an FHV over a wired connection; communicatively linking wirelessly with a mobile computing device disposed within the FHV; and transmitting the odometer, time, and/or location information over the wireless link while the FHV is in transit. The process may further include receiving a GPS signal using a GPS receiver that is not part of the FHV's OBD system.

In certain embodiments, the process further includes providing pass-through OBD signals to a directed taximeter device disposed within the FHV over a wired connection. The pass-through OBD signals can be provided over a 16-pin female connection port. In certain embodiments, linking with the mobile computing device includes pairing with the mobile computing device over a BLUETOOTH connection. Furthermore, said receiving, linking, and transmitting may be performed automatically. The process may further include communicatively linking wirelessly with a passenger mobile device.

Certain embodiments disclosed herein provide an on-board vehicle diagnostics device including a housing; an on-board diagnostics (OBD) engagement member configured to physically engage with an OBD port of a for-hire vehicle (FHV) and receive power and data communications therefrom; and computer circuitry disposed at least partially within the housing configured to receive GPS information associated with a trip taken by the vehicle, the information being received through the OBD port of the vehicle. The computer circuitry may be further configured to wirelessly communicate with one or more computing devices disposed within the FHV over a local area network when the on-board diagnostics device is connected to the OBD port.

### Transportation Control and Regulation

Certain embodiments disclosed herein provide systems and methods for monitoring and regulating for-hire vehicles (FHV). A server receives and stores information relating to authorized vehicles (often based on medallions assigned by the local government transportation agency), algorithms and parameters for FHV fare calculation, as well as information about authorized drivers and authorized dispatchers, from one or in some cases several regulatory entities each of which covers an FHV regulatory jurisdiction (often defined using geographic boundaries although these jurisdictions may also be defined by type of service, type of vehicle or in some other way that may be established in the local area). The server receives time and/or distance data associated with an FHV trip from a device (usually a mobile device like a smart phone for example) traveling with the FHV and uses such information to calculate a fare for the trip. The server is configured to receive requests for transportation services from mobile devices, and to dispatch FHVs, either directly (by automatically sending a dispatch signal to the selected FHV) or through a third-party (such as a traditional dispatch service), to accommodate such requests. The collected real-time information may advantageously be used to optimize the utilization of FHV resources.

Certain embodiments disclosed herein provide a for-hire vehicle (FHV) vehicle dispatch, fare calculation and medallion monitoring system. The system includes a server including a computer memory and a processor for calculating FHV trip fares, wherein the computer memory is configured to store at least the following information provided by a regulatory entity: one or more fare calculation algorithms; fare calculation parameters; valid medallions granted by the regulatory entity; geographical boundary information; and at least one dispatcher approved to operate within a jurisdiction of the regulatory entity. The system further includes a FHV mobile device communicatively coupled to an on-board diagnostics (OBD) system of an FHV, the FHV having a valid medallion, and identification of the medallion stored in the computer memory, the FHV mobile device being configured to transmit location, time and/or distance information from the OBD system to the server, as well as a customer mobile device configured to transmit a request for transportation service to the server, wherein the server provides a corresponding dispatch request to a approved dispatcher. The server is configured to calculate an FHV trip fare based at least in part on the time and/or distance information and the information provided by the regulatory entity.

The system may further include a dedicated taximeter disposed within the FHV, wherein the taximeter is configured to operate independently of the server. In certain embodiments, the approved dispatcher is part of the server. Alternatively, the approved dispatcher may be separate from the server. The approved dispatcher may automatically dispatch an FHV to a designated pick-up location in response to receiving the request from the server. In certain embodiments, the system further includes a fleet operator entity, wherein the server provides information relating to a fleet of FHVs controlled by the fleet operator.

Certain embodiments disclosed herein provide a process of managing for-hire vehicle (FHV) vehicle dispatch, fare calculation and medallion operations. The process includes receiving the following information from a regulatory entity: one or more fare calculation algorithms; fare calculation parameters; valid medallions granted by the regulatory entity; and at least one dispatcher permitted to operate within a jurisdiction of the regulatory entity. The process further includes storing the information from the regulatory entity in computer storage; receiving time and/or distance information from a mobile device communicatively coupled to an on-board diagnostics (OBD) system of an FHV, the FHV being associated with a valid medallion stored in the computer storage; receiving a request for transportation service from a customer mobile device; providing the request for transportation to a permitted dispatcher; and calculating an FHV trip fare based at least in part on the time and/or distance information and the information from the regulatory entity.

In certain embodiments, the process further includes operating a dedicated taximeter disposed within the FHV. The permitted dispatcher may be remotely located. The process may further include automatically dispatching, by the permitted dispatcher, an FHV, based on the request for transportation. The process may further include providing information to a fleet operator entity relating to a fleet of FHVs controlled by the fleet operator.

Certain embodiments disclosed herein provide a process of managing multi-jurisdictional for-hire vehicle (FHV) activity. The process may include receiving registration information from a user, determining that the user is located within a first jurisdiction, servicing a first FHV transaction of the user using first trip-related information when the user is located within the first jurisdiction, determine that the user is located within a second jurisdiction, and servicing a second FHV transaction of the user using second trip-related information when the user is located within the second jurisdiction. The process may further include receiving first regulation data from a first regulatory entity and receiving second regulation data from a second regulatory entity, wherein the first trip-related information includes the first regulation data and the second trip-related information includes the second regulation data. The process may further include receiving regulation data from a regulatory entity, wherein the first trip-related information and the second trip-related information include the regulation data.

In certain embodiments, the process includes providing a software application to the user, wherein the user initiates the first FHV transaction using the software application. The first and second trip-related information may include fare calculation parameter and algorithm information or geographical zone and/or jurisdiction boundary information. Furthermore, the first trip-related information may include taxi company information associated with the first FHV transaction; the second trip-related information may include taxi company information associated with the second FHV transaction.

Certain embodiments disclosed herein provide a multi-jurisdictional for-hire vehicle (FHV) management system including a computer memory and computer hardware including a processor in communication with the memory. The processor is configured to receive registration information from a user, store the registration information in the computer memory, determine that the user is located in a first jurisdiction, service a first FHV transaction of the user using first trip-related information when the user is located within the first jurisdiction, determine that the user is located in a second jurisdiction; and service a second FHV transaction of the user using second trip-related information when the user is located within the second jurisdiction.

The processor may be further configured to receive first regulation data from a first regulatory entity and receive second regulation data from a second regulatory entity, wherein the first trip-related information includes the first regulation data and the second trip-related information includes the second regulation data. The processor may be further configured to receive regulation data from a regulatory entity, wherein the first trip-related information and the second trip-related information include the regulation data.

In certain embodiments, the processor is further configured to provide a software application to the user, wherein the first FHV transaction is initiated by the user using the software application. The first and second trip-related information may include fare calculation parameter and algorithm information or geographical zone and/or jurisdiction boundary information. Furthermore, the first trip-related information may include taxi company information associated with the first FHV transaction; the second trip-related information may include taxi company information associated with the second FHV transaction.

Certain embodiments disclosed herein provide a computer-implemented process of optimizing for-hire vehicle (FHV) activity. The process includes collecting FHV activity data indicating real-time positions of a plurality or FHVs in a first jurisdiction and the status, including whether the FHV is currently transporting a customer, and, if so, the customer's destination and estimated time or arrival; receiving a plurality of requests for transportation services from one or more consumers; calculating estimated distance and/or travel time between a designated pick-up location and each of the plurality of FHVs; and using the information regarding the current and expected positions of the plurality of FHVs to dispatch one FHV of the plurality of FHVs based at least in part on the calculated distance and/or travel time and the current and future expected locations of the plurality of FHVs.

In certain embodiments, at least one of the plurality of FHVs is owned and operated by a first entity and at least one of the plurality of FHVs is owned and operated by a second entity. Furthermore, at least one of the plurality of FHVs may be located within a first regulatory jurisdiction while at least one of the plurality of FHVs is located within a second regulatory jurisdiction. Dispatching the one FHV of the plurality of FHVs may be performed automatically. Automatically dispatching the FHV may include dispatching an FHV to pick up the consumer at a location in a first geographical jurisdiction from a second geographical jurisdiction in order to meet demands of the first geographical jurisdiction.

The embodiments of the disclosure and the various features and details thereof are explained more fully with the reference to the non-limiting embodiments and examples that are described and/or illustrated in the accompanying drawings and detailed in the following description. It should be noted that the features of one embodiment may be employed with other embodiments as the skilled artisan would recognize, even if not explicitly stated herein. Descriptions of well-known modules and computing techniques may be omitted so as to not obscure the teaching principals of the disclosed embodiments unnecessarily. The examples used herein are intended merely to facilitate an understanding of ways in which the disclosure may be practiced and to further enable those skilled in the art to practice disclosed embodiments. The examples and embodiments herein should not be construed as limiting.

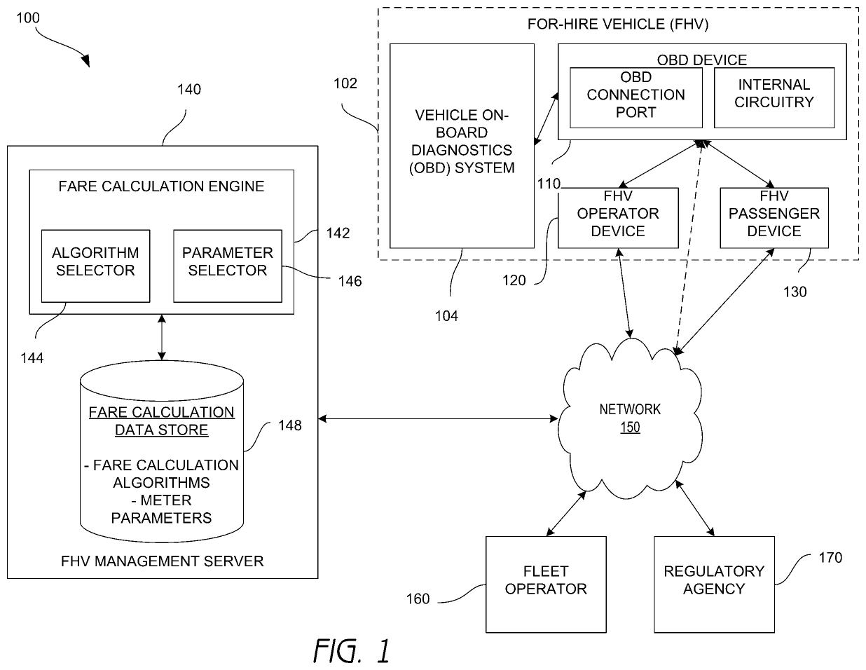

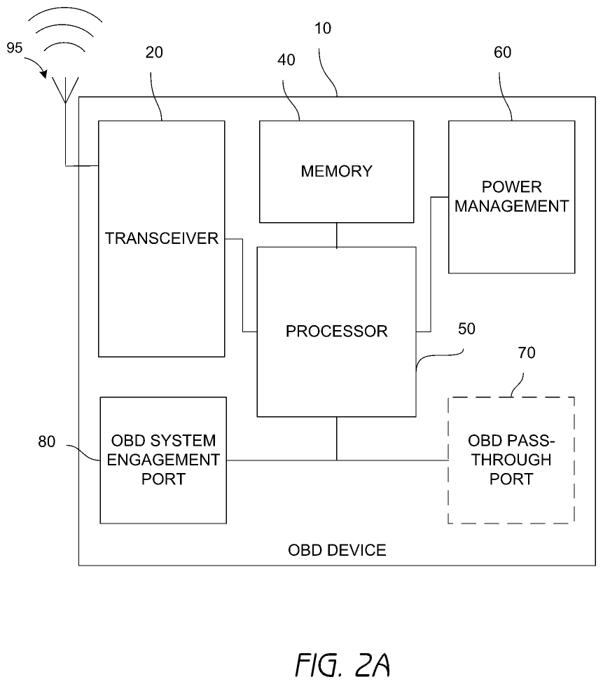

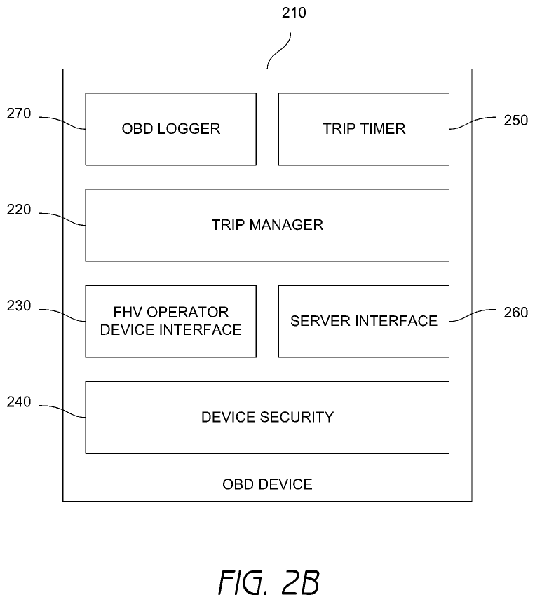

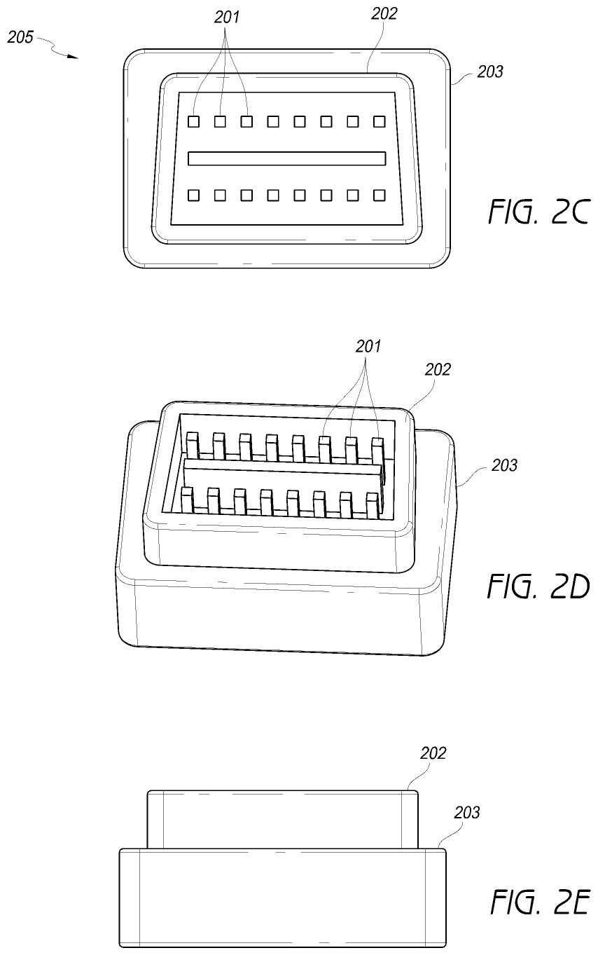

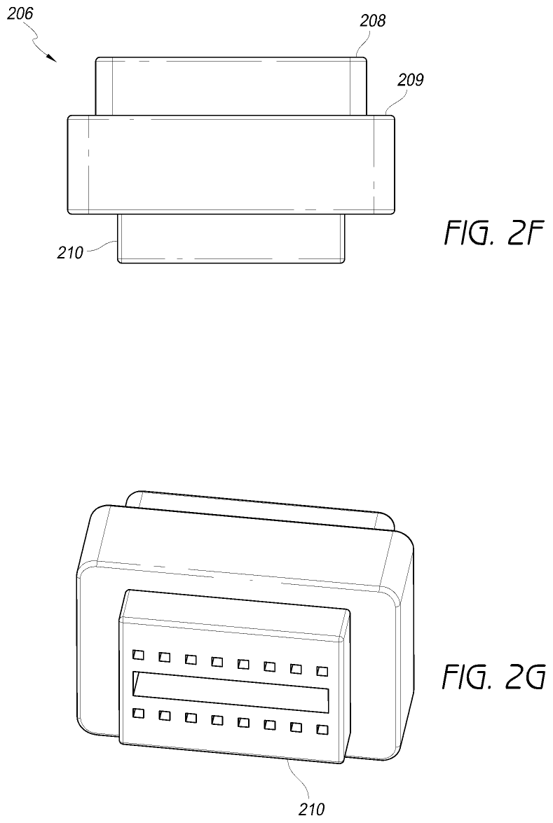

Embodiments disclosed herein relate to systems and methods for providing streamlined operation and/or regulation of FHVs with respect to FHV operators (for example, drivers), FHV passengers, fleet operators, and/or regulatory agencies. Embodiments disclosed herein may be applicable to both systems incorporating live vehicle operators as well as systems incorporating autonomous FHVs. FIG. 1 provides an embodiment of a system for managing and/or regulating taximeter operation. The system 100 may include an FHV 102 having one or more mobile computing devices (110, 120, 130). The mobile computing devices are connected to an FHV management server 140 over a computer network 150. For example, the computer network 150 may be a wide area network (WAN), such as a WAN utilizing the Internet for interconnectivity. The computing device 110 may be an on-board diagnostic (“OBD”) device configured to be physically connected to the FHV's on-board diagnostics system 104 and receive signals therefrom through an OBD connection port. The OBD device further includes internal circuitry for processing and/or transmitting vehicle diagnostics or operational signals. Such a device is discussed in greater detail below with respect to FIGS. 2B-2G. In certain embodiments, the OBD device includes embedded software for collecting and providing information related to time, location, and/or distance, such as the distance traveled or location of the FHV with which it is associated.

The system 100 may allow for communication between the server 140 and/or one or more other devices or modules connected to the network 150. For example, the server 140 may receive time, distance, and/or location information from the OBD device 110 over the network 150 and provide various information, such as calculated ride-fare information, back to the OBD device 110 over the network 150. In certain embodiments, the OBD device 110, FHV operator device 120, and/or FHV passenger device 130 communicate such information to the FHV management server 140 through wireless transmission. In certain embodiments, the OBD device 110 is a computer that has software installed thereon for performing such communication. For example, the OBD device 110 can include a radio transceiver for communicating wirelessly using one or more standard communication protocols, such as BLUETOOTH or Wi-Fi.

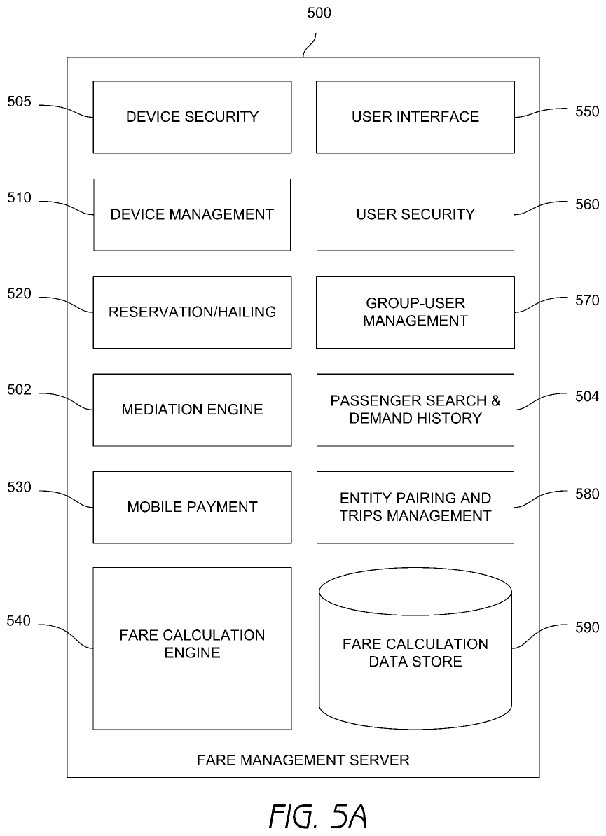

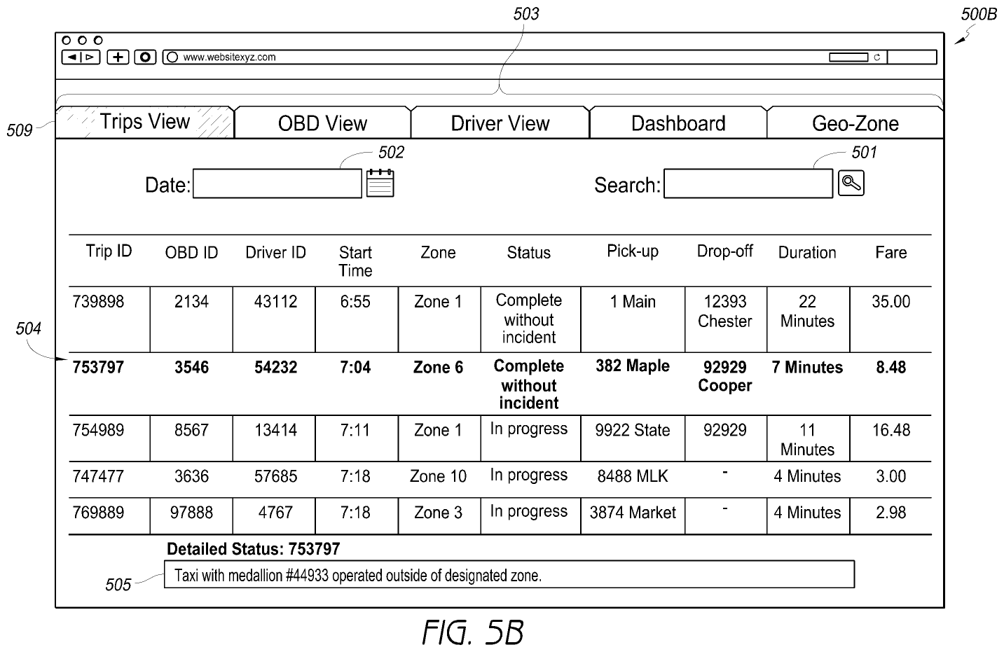

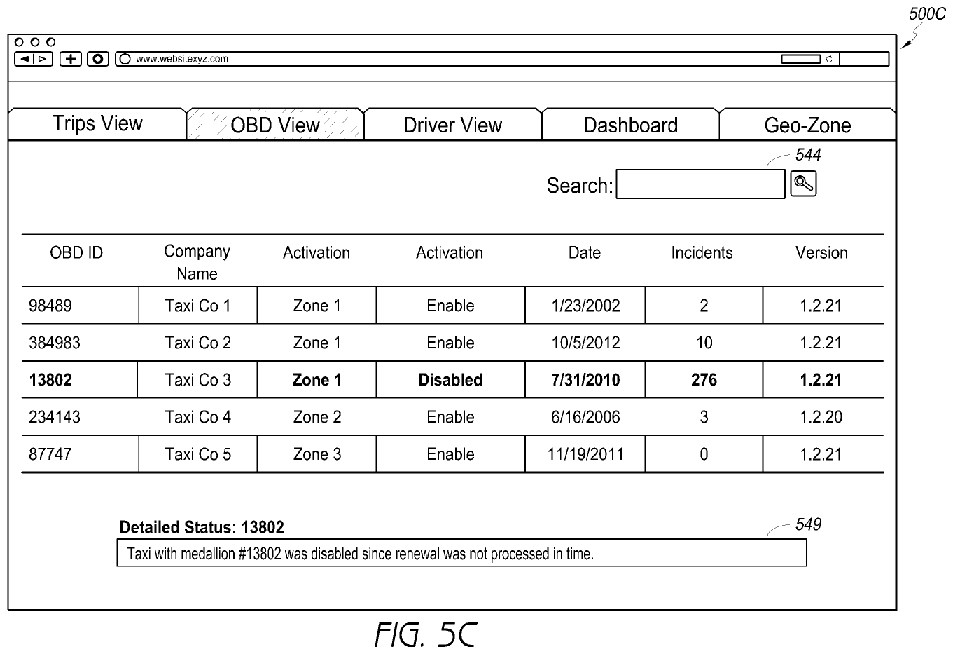

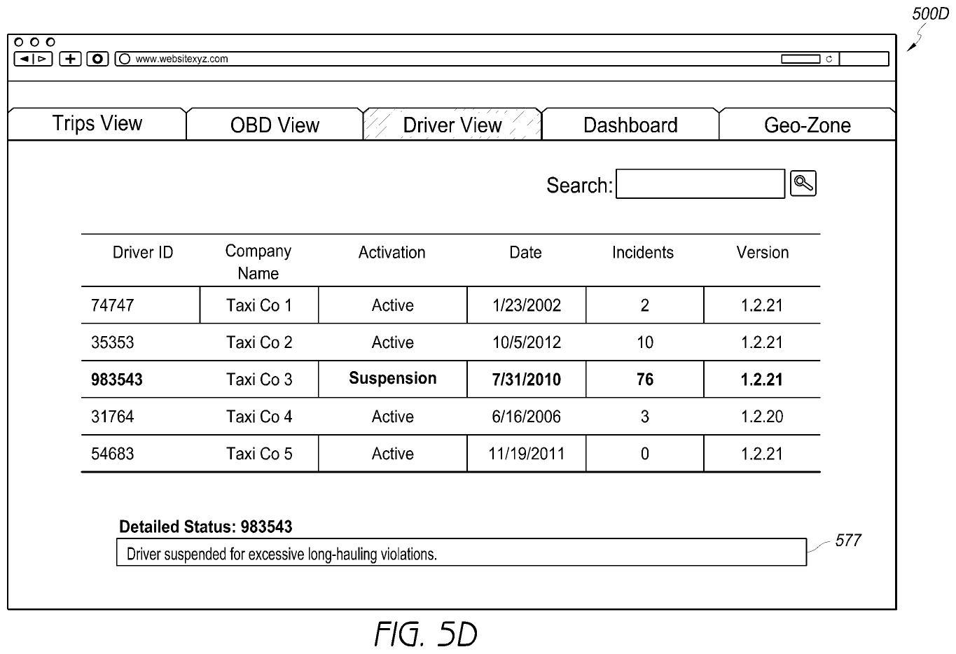

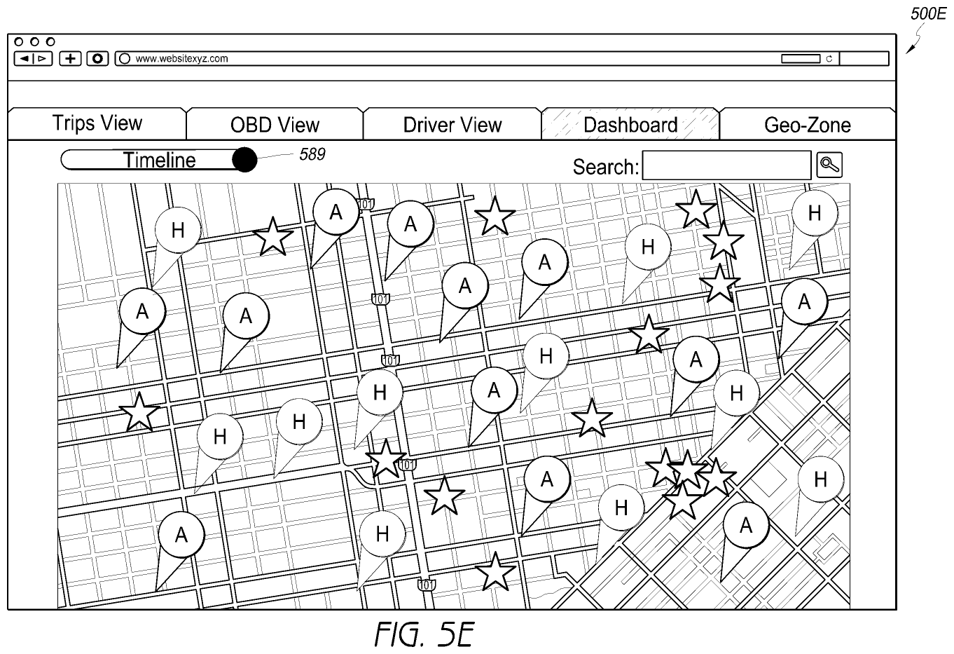

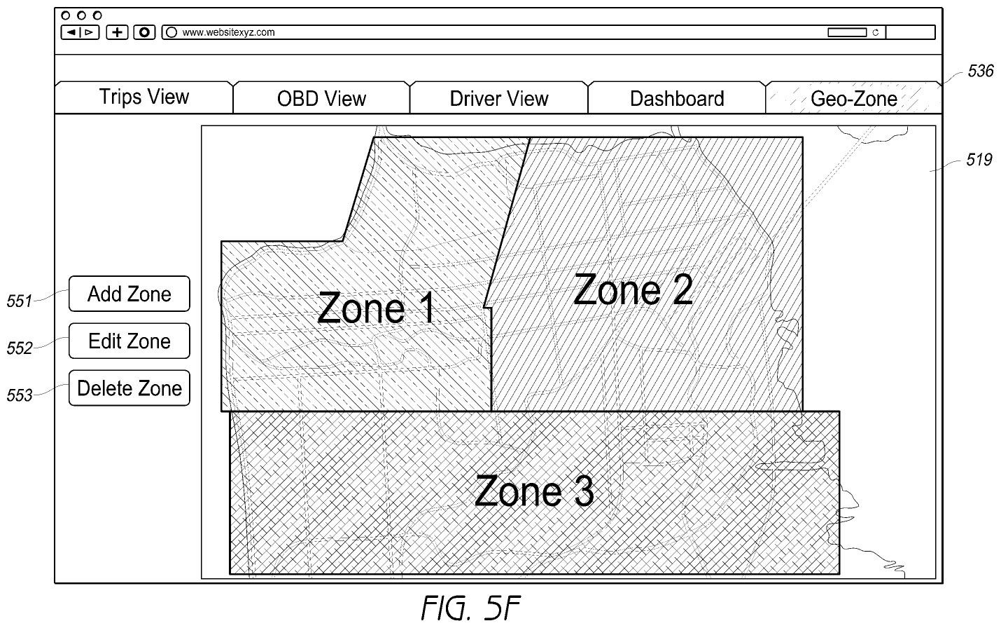

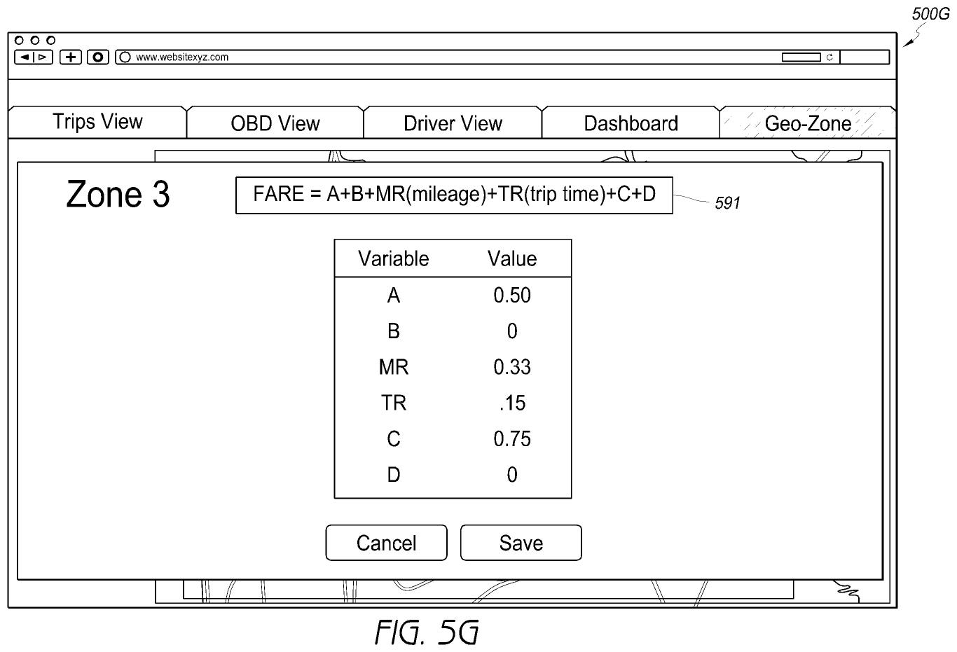

The FHV management server 140, as described in greater detail below with respect to FIGS. 5A-5G, may be a server utilized to run one or more fare-calculating functions to serve one or more entities or devices, such as entities associated with FHVs (e.g., vehicle operators, passengers, fleet operators, regulatory agencies, and/or others). The server 140 may communicate over the network 150 with one or more mobile devices, such as by using downloadable and/or server-based software applications. For example, the server 140 may be configured to communicate with a mobile device 120 to which a vehicle operator of an FHV has access, such as a laptop, tablet, smartphone, or other mobile device. Such a device may have software downloaded thereon providing functionality for communicating with the server 140. The FHV operator device 120 may provide information input by the vehicle operator, or otherwise obtained, to the server 140. For example, such information may relate to time, distance, or location of a trip taken, or to be taken, by the FHV.

The system may be configured to account for situations where connections between the server 140 and one or more of the wireless devices 110, 120, 130 are unavailable or become disconnected. One or more of the wireless devices may be configured to operate off-line. For example, a local area network may be established within the FHV 102, wherein two or more of the wireless devices disposed therein may connect over such network, such as over a BLUETOOTH connection. In a situation where connection with the FHV management server 140 is unavailable, the local mobile devices may continue to interact and receive and log trip-related data. Once a connection with the server 140 is established, recorded data may be uploaded and processed by the server. If one or more mobile devices is unable to establish a connection with the server 140, but one or more other devices are able to establish a connection, the server 140 may rely on information received from the connected device or devices for calculating trip fares.

Furthermore, the FHV management server 140 may communicate with a passenger-operated mobile device 130, such as a personal computer, tablet, or smartphone. The passenger device 130 may have software downloaded thereon that allows for data input by a user, collection of data from one or more integrated sensors, and/or transmission functionality for communicating with the server 140 over the network 150.

Certain applications utilized in the system 100 provide information, control and/or user interfaces to automate or enable tasks of various system modules. For example, in certain embodiments, embedded/local and server-side software in the system 100 perform operations based at least in part on control information received from user applications on mobile devices; software may also cause the server to exchange information with one or more user applications, and store information related to user activity/input.

In the context of an FHV trip, the system 100 may be configured to collect or receive FHV trip distance and duration time from the OBD device 110, FHV operator device, and/or passenger device. In certain embodiments, the system 100 calculates trip fares using server-side software based on collected FHV trip distance and trip duration time information from the OBD device 110. In certain embodiments, the system 100 uses GPS data from an OBD device, FHV operator device, and/or passenger device, to calculate fares. For example, GPS data mapping a trip of an FHV may allow for calculation of time/distance and may therefore be useful in fare calculation. With respect to OBD devices, GPS signals may be provided from a GPS receiver integrated in the OBD device, or may be provided by the FHV's OBD system, wherein the OBD device obtains such information though the OBD interface, and retransmits the data, or a modified version thereof, to the server. In certain embodiments, fare calculation is performed based on a combination of time/distance and GPS data received remotely by the server.

The system 100 may advantageously display the fare on a display associated with an FHV operator device, or other device, such as a dedicated taximeter or other in-vehicle display. In certain embodiments, the system 100 displays the fare on the passenger device 130 in addition to, or in alternative to, display on the FHV operator device or any other on-board meter device. Display, calculation, and/or receipt of fare calculation information by or from more than one source device in the system 100 may provide improved confidence of the correctness of the fare.

With further reference to FIG. 1, the system 100 may collect FHV trip distance and/or trip duration from the FHV operator device 120 and/or passenger device 130. For example, such information may be received or obtained by the FHV management server 140 during or subsequent to a trip. In certain embodiments, the system 100 validates a first method of fare calculation with one or more other methods of fare calculation, as described herein. Such calculations may be based on signals from one or more GPS receivers, software-based timer applications, or other information provided by mobile devices in the system. Additional validation methods may be desirable in order to confirm that the first method is accurate or operating properly. Discrepancies in fare calculation between one or more methods may cause the system to notify the FHV operator, passenger, fleet operator, and/or regulatory agency associated with the specific trip. When discrepancies occur, fare calculation may include consulting historical data for similar trips to determine an appropriate fare. For example, the system 100 may include a mediation engine module configured to determine the fare based on collected FHV trip distance data and trip time data from the OBD device 110, FHV operator device 120 and/or passenger application 130.

In certain embodiments, the system 100 includes one or more FHVs having dedicated taximeter boxes, wherein the meters do not contain embedded software configured to interface with server-side fare calculation software. A dedicated taximeter may be a dash or ceiling-mounted box configured to be electrically coupled to the vehicle's OBD system and to calculate trip fares and display such fares for vehicle occupants. In certain embodiments, an OBD device 110 includes a pass-through connector configured to enable an OBD connector of a dedicated taximeter box to connect to the OBD device to allow for connectivity of both the dedicated taximeter and the OBD device 110 to the FHV's computer system. With respect to OBD devices with pass-through connectors, the system 100 are configured to monitor FHV trip distance, trip duration and/or validate the calculation of the dedicated meter box using fare-calculation functionality of the server-side software.

With further reference to FIG. 1, the FHV management server may include a fare calculation data store 148. The fare calculation data store may store information relating to taximeter parameter values for one or more regulatory jurisdictions. As discussed above, fare calculations may be made using varying parameters, depending on geographical location, time, or other factors. In certain embodiments, a regulatory agency 170 may update parameter values stored in the data store 148 such that calculations made by the server 140 may incorporate such updates. The fare calculation data store 148 may further include stored fare calculation algorithms for use in fare calculation by the fare calculation engine 142.

As referenced, the FHV management server 140 may additionally include a fare calculation engine 142 configured to calculate trip fares based on data received from one or more devices connected to the network, as well as data stored in the fare calculation data store 148. An algorithm selector module 144 may select one or more algorithms from among a plurality of fare calculation algorithms stored in the data store 148 for calculating the relevant fare. For example, algorithms may be selected for fare calculation based on the location of the FHV, wherein different algorithms correspond to different geographical jurisdictions or zones. Furthermore, algorithm selection may be based on other factors, such as vehicle type, date, time, and the like. Parameter values used in connection with such algorithm(s) may likewise be obtained from the data store. A parameter selector module 146 may select a parameter or set of parameters stored in the data store 148, as appropriate for the particular fare calculation. Algorithm and/or parameter selection may be based on regulatory jurisdiction, timing, events, or other factors associated with the trip.

The OBD device 110 may be configured to collect diagnostic information from the FHV through the FHV's OBD system interface, remotely connect to the FHV management server 140 (such as through a direct internet connection, or via a local connection with another mobile device), and exchange information with server-side software and/or FHV operator device(s) during or subsequent to passenger transport. Embedded software of the OBD device 110 may use an on-board diagnostic interface to collect operational information from the FHV. Operational information can include, but is not limited to, odometer, vehicle identification number (VIN), trip mileage, and speed. In addition, the OBD software may also be configured to calculate trip duration time. The embedded software may receive start and stop commands from the FHV operator device 120 to begin and end an FHV trip. When the device receives the start command, the embedded application may log the distance and/or elapsed-time information, and send the information to the FHV management server 140 over the network 150.

The FHV operator device 120 may include software configured to provide a user interface mechanism to facilitate identification and location of potential passengers, input of trip start/end information, and display real-time and/or final fare information. The FHV operator device 120 may communicate with other modules of the system 100, such as OBD device/software, FHV passenger device/software, and server-side software via a local area network (LAN), wide area network (WAN) 150, or combination thereof.

As discussed above, the system 100 may include a passenger application that runs on a passenger's/consumer's mobile device 130. In certain embodiments, the passenger application provides a user interface that is displayed on the mobile device 130 and allows the passenger to locate an FHV, hail an FHV remotely, view a map showing route-related points, and/or see real-time or final fare values. The passenger application may communicate with the server-side software for sending or receiving real-time fare calculations, trip data, notifications, or other trip-related information.

In certain embodiments, the system includes an on-board electronic device configured to transmit GPS data to the server 140, either directly, or via one or more mobile computing devices disposed within the vehicle 102. The device may not be connected to the vehicle's OBD system. For example, the device may be disposed somewhere within or without the vehicle, wherein a GPS receiver of the device transmits a signal associated with the location of the vehicle. In certain embodiments, the system 110 includes the GPS on-board device in addition to, or in place of, the OBD device 110.

FIG. 2A illustrates an embodiment of an OBD device 10 configured to be electrically coupled to the OBD system of a car in accordance with one or more aspects of the present disclosure. Although FIG. 2A illustrates a device having wireless transmission capability, applications of the present disclosure are not limited to wireless devices and can be applied to OBD devices providing only for wired communication. The OBD device 10 shown includes a transceiver module 20 capable of both transmitting and receiving signals wirelessly. However, in certain embodiments, the OBD device 10 has only transmission capabilities. In certain embodiments, the transceiver 20 includes multiple signal-processing components. For example, the transceiver 20 may include discrete components for amplification and/or filtering of signals in compliance with one or more wireless data transmission standards, such as BLUETOOTH, GSM, WCDMA, LTE, EDGE, Wi-Fi, etc. In certain embodiments, the transceiver 20 can include a digital to analog convertor (DAC), a user interface processor, and/or an analog to digital convertor (ADC), among possibly other things.

The transceiver 20 is electrically coupled to a processor 50, which processes signals received and/or transmitted by one or more antennas 95. Such processing may include, for example, signal modulation, encoding, radio frequency shifting, or other functions. The processor 50 may operate in conjunction with a real-time operating system in order to accommodate timing dependant functionality.

The processor 50 is connected, either directly or indirectly, to a memory module 40, which contains one or more volatile and/or non-volatile memory/data storage devices or media. Examples of types of storage devices that may be included in the memory module 40 include Flash memory, such as NAND Flash, DDR SDRAM, Mobile DDR SRAM. Furthermore, the amount of storage included in memory module 40 may vary based on one or more conditions, factors, or design preferences. For example, memory module 40 may contain approximately 256 MB, or any other suitable amount, such as 1 GB or more. The amount of memory included in OBD device 10 may depend on factors such as, for example, cost, physical space allocation, processing speed, storage demand, and the like.

The OBD device 10 may include a power management module 60. The power management module 60 may include, among possibly other things, a battery or other power source, or may be configured to receive power from an external power source, such as from the vehicle OBD system over the OBD system engagement port 80. In addition, the power management module 60 may include a controller module for management of power flow from the power source to one or more regions of the OBD device 10. Although the power management module 60 may be described herein as including a power source in addition to a power management controller, the terms “power source” and “power management,” as used herein, may refer to either power provision, power management, or both, or any other power-related device or functionality.

The OBD device 10 may further include a pass-through OBD port 70 configured to provide a female engagement portion for plugging in devices designed to connect to a vehicle's OBD system port. For example, a dedicated taximeter disposed within an FHV may be plugged into the OBD device 10, thereby allowing the taximeter to receive system OBD signals therethrough. In certain embodiments, the signals available at the pass-through port 70 are substantially identical to those available at the vehicle's OBD port. In certain embodiments, the pass-through port provides modified signals, or a subset of signals from the vehicle's OBD port. For example, with respect to a dedicated taximeter device, the pass-through port 70 may provide only signals utilized by the taximeter.

The components described above in connection with FIG. 2B and the OBD device 10 are provided as examples, and are non-limiting. Moreover, the various illustrated components may be combined into fewer components, or separated into additional components. For example, processor 50 can be at least partially combined with the transceiver 20. As another example, the transceiver 20 can be split into separate receiver and transmitter portions.

FIG. 2B illustrates a block diagram representing an embodiment of an OBD device. For example, the OBD device 210 may be the device 110 shown in FIG. 1. The diagram contains certain functional blocks representing OBD software and hardware modules running on the OBD device 210. For example, the OBD device 210 may include a trip manager module 220, which may be a central functional block of the OBD software. The trip manager 220 may advantageously be configured to manage start/stop operations relating to an FHV trip and collect trip distance and trip time data. In certain embodiments, the trip manager receives signals from the FHV operator device 120 indicating start/stop events associated with an FHV trip. For example, when the trip manager 220 receives a start-trip signal, the trip manager module 220 may be configured to enable an OBD logger module 270 to access the FHV computer and periodically collect mileage data from the FHV computer.

The trip manager 220 may further enable a trip timer module 250 to start a trip timer. As described above, distance information may be provided to the OBD device from the FHV's internal computer system, such as odometer or RPM information provided through the vehicle's OBD interface. In certain embodiments, the OBD device is configured to receive distance information from the vehicle's transmission line indicating RPM of the transmission output. Such transmission signal may be directly coupled to the OBD device, or may be acquired by the OBD device indirectly through a dedicated taximeter box. For example, a taximeter device may be configured to receive a pulse signal indicating output RPM from the transmission to calculate trip distance. In certain embodiments, the system may integrate with dedicated taximeter boxes through signals generated by the meter to coordinate the beginning and end of trips. For example, dedicated taximeter boxes can generate signals to toggle lighting on or inside the FHV to indicate availability of the FHV when the FHV operator presses ‘hired’ or timer off buttons. By tapping the signal to such signals for lights, or otherwise intercepting the signal from the taximeter, the OBD device or FHV operator device can detect the beginning or end of a trip via the dedicated taximeter box. Such information may be used by the system server to calculate fares.

In certain embodiments, the trip manager 220 periodically or at irregular intervals, transmits trip mileage data, trip elapsed time data, or FHV VIN or OBD ID data to the software for real-time calculation of the trip fare using the appropriate fare calculation algorithm/parameters for the given jurisdiction. When the trip manager receives the FHV trip end signal, the trip manager 220 may stop the OBD logger 270 and trip timer 250. The final trip distance and/or trip elapsed time may be sent to the server-side software for the calculation of the final fare. The fare calculation is therefore performed remotely through a network connection. When the fare-calculation server is connected to the OBD device 210 over the Internet, the server effectively acts as a “cloud” taximeter. In such embodiments, it may not be necessary for local hardware and/or software to implement trip fare calculations.

By maintaining fare calculation parameters and functionally at an internet-accessible server, fare-calculation information may be accessible to multiple potentially interested entities having access to the server, thereby providing improved transparency and simplified regulation of services. For example, regulatory agencies or fleet owners/operators may have access to fare-calculation information or other FHV activity-related information that would otherwise be unavailable, or difficult to obtain. In certain embodiments, the server-side software may download the fare calculation engine and meter parameters for specific jurisdictions onto the OBD device or FHV operator device for local calculation of the fare. After ending a trip, the trip manager may store information relating to the most recent trip in local persistent memory and prepare the OBD device 210 for the next trip.

The OBD device 210 may further include an FHV operator device interface module 230 that facilitates two-way communication between the OBD device 210 and an FHV operator device. For example, the OBD device may be configured to link with an FHV operator device over a BLUETOOTH or other connection. The FHV operator device interface 230 may receive command signals from the FHV operator device, parse the signal, and send the parsed information to the trip manager module 220. The FHV operator device interface 230 may further serve to format response data to be sent from the OBD device to the FHV operator device to indicate status.

The OBD device 210 may further include a server interface module 260 that is configured to facilitate two-way communication between the OBD device and the server-side software in the cloud. For example, the server interface 260 may send FHV trip information periodically or at irregular intervals to a server-side application for use in fare calculation. In addition, the server interface 260 may be used to send status information to the server. The server interface 260 may also receive response signals from the server for determining system status information.

The OBD device 210 may further include a device security module 240 configured to facilitate system security by managing device authentication and authorization between the OBD device and FHV operator device and between the OBD device and the remote system server. For example, the security module 240 may implement any suitable cryptographic system, such as public/private key. In certain embodiments, a device-specific ID, such as a Media Access Control (MAC) address or other unique device ID is used to limit access to devices with known and approved hardware IDs. Such identification mechanism may represent a first level security check to ensure that authorized hardware and operating system platforms can access other system software or applications.

The OBD software may further include device security that enables network security functionality. In certain embodiments, the device security module 240 utilizes public-private key methods to encrypt data exchanged between the OBD device and the remote fare-calculation server and FHV operator devices. Furthermore, the device security module may be configured to use application-level security to ensure that an application has the proper credentials to communicate with other applications and software within the system.

In certain embodiments, the OBD device 210 includes a GPS module for receiving and/or processing GPS signals. Such information may be used to locally calculate trip fares, or may be provided to one or more external devices, wherein the information is used to calculate trip fares. For example, a GPS module of the OBD device may provide GPS data to a remote server, either directly or through another mobile computing device, wherein the remote server performs fare calculations.

FIG. 2C illustrates a top view of an OBD device 205 that may be used in one or more embodiments disclosed herein. As shown, the OBD device 205 includes a plurality of electrical connectors, or pins 201. The pins 201 may be configured to communicate with corresponding contacts of an OBD connection port of a vehicle. The OBD device 205 may be configured to receive self-diagnostic or operation information from the vehicle's OBD system. Such information may relate to a number of operational parameters of the vehicle, which may vary depending on the vehicles particular configuration. Examples of such information may include, for example, information related to fuel system status; mileage; engine load values; engine coolant temperature; fuel pressure; engine RPM; vehicle speed; oxygen content; engine runtime; vehicle identification number (VIN); and/or other vehicle parameters.

The OBD device 205 may be configured to be physically connected to the vehicle's OBD system according to one or more standard protocols, as understood by those having ordinary skill in the art. Examples of such protocols, or interfaces, may include, for example, ALDL; OBD-1; OBD-1.5; OBD-II; EOBD; EOBD2; JOBD; ADR, or others. The OBD device 205 may perform data-logging tasks, wherein the values associated with one or more parameters of the vehicle are recorded in the OBD device 205 for real-time or later use. The OBD device 205 may be configured to output data stored thereon, or processed thereby, to a user. For example, in certain embodiments, the OBD device 205 includes a communication port from which data stored or processed by the OBD device 205 may be accessed. For example, the OBD device 205 may include a communication port for insertion of an electronic cable or other device through which such information may be extracted. In certain embodiments, the OBD device 205 is configured to wirelessly transmit data. For example, the OBD device may include a radio for transmitting and/or receiving wireless signals according to one or more data communication protocols, such as BLUETOOTH, Wi-Fi, and the like.

In certain embodiments, the OBD device 205 is configured to receive electrical power from a power source, such as from the vehicle over one or more of the electrical connection pins 201. For example, such power may be provided to the OBD device 205 when the vehicle is turned on, and the OBD device 205 may therefore lose power upon vehicle shutdown. The OBD device 205 may include electronic circuitry for performing one or more signal processing and/or transmission functions. For example, the OBD device 205 may include circuitry comprising a computer processor and computer memory. For example, the computer memory may be non-volatile memory, such that data may be acquired from the vehicle's OBD system for later use or retrieval after power supplied to the OBD device 205 is turned off. In certain embodiments, the OBD device includes a local power source, such as a battery, for providing power to the OBD device as a supplement to, or in place of, power provided by the vehicle. For example, the OBD device 205 may be configured to transmit certain vehicle parameters, such as position or time over a network when the vehicle is not running.

The OBD device 205 may include a circuitry housing portion 203 as well as a male engagement portion 202 for engaging a corresponding OBD connection port of the vehicle. Such connection port may be located, for example, under a steering wheel of the vehicle. The circuitry housing portion 203 may include one or more electronic components or devices, such as a computer processor, GPS receiver, radio transceiver, or other components. The outer housing or casing of the OBD device 205 may comprise a rigid material, such as plastic or other material configured to withstand physical pressure or contact without substantial harm to the internal components of the device.

FIG. 2D illustrates a perspective top and side view of an OBD device 205, while FIG. 2E illustrates a side view of such device. As shown in FIG. 2E, the male engagement portion 202 may extend vertically from the circuitry housing portion 203 such that the male engagement portion 202 may be inserted into the corresponding OBD connector of the vehicle.

FIG. 2F illustrates a side view of an embodiment of an OBD device 206 including a pass-through connector portion 210. The pass-through connector portion 210 may be configured to provide a female communication port similar to the OBD connector of the vehicle. Therefore, in certain embodiments, the OBD device 206 may be engaged with vehicle's OBD connector port, while allowing for access to OBD signals provided through such port to other devices. For example, in certain embodiments, a dedicated taximeter configured to be communicatively coupled to the vehicle's OBD system may be connected thereto through the OBD device 205, rather than through direct connection to the vehicles OBD communication port. FIG. 2G provides a perspective view of the OBD device 206. As explained, the pass-through connection port may engage an ODB port connector of a dedicated taximeter box. The pass-through connection port may advantageously allow for a dedicated taximeter box to connect to the vehicle's OBD system in a similar manner as it would without the OBD device 205 occupying the vehicle's OBD port.

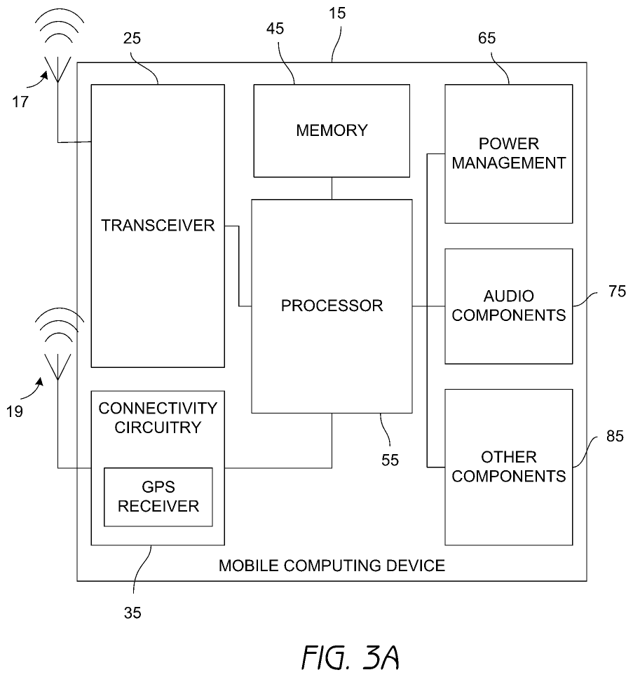

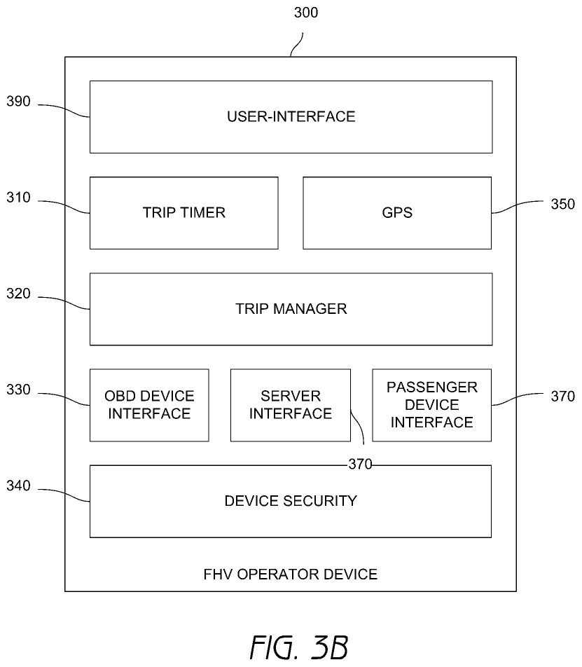

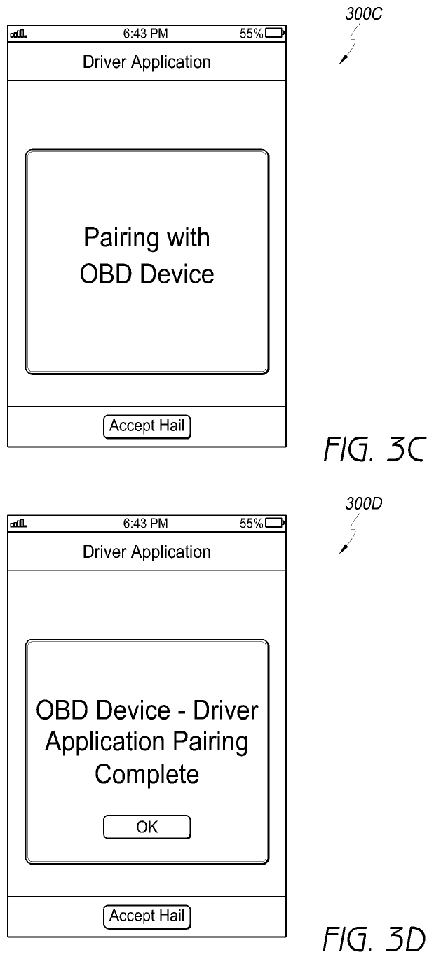

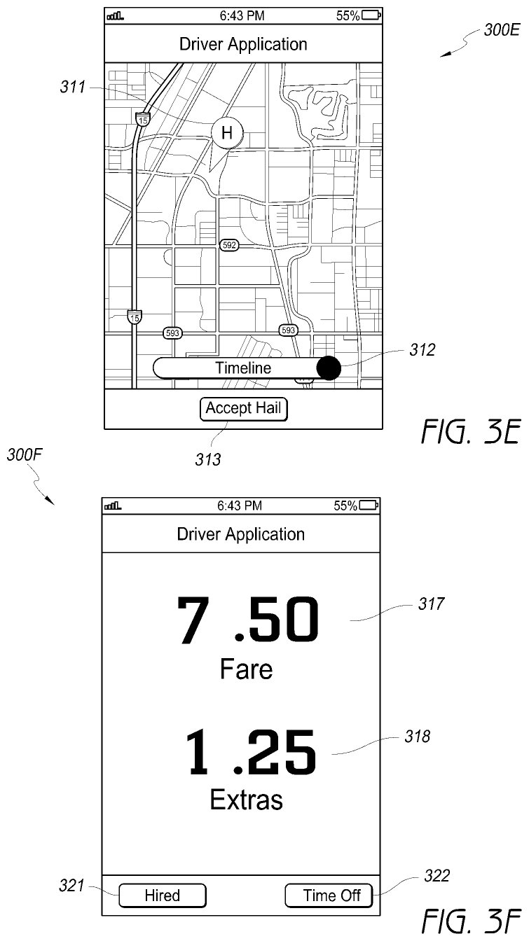

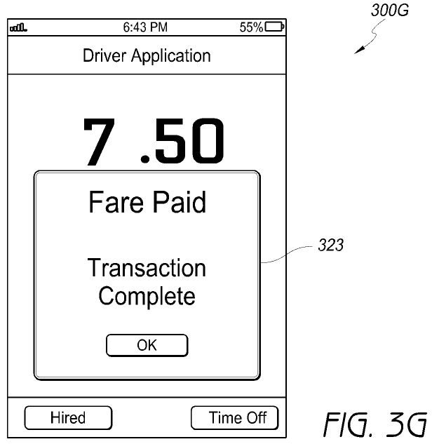

FIG. 3A illustrates an embodiment of a mobile computing device 15 in accordance with one or more aspects of the present disclosure. The mobile computing device may be a passenger device or FHV operator device, as described herein with respect to certain embodiments. As an example, the mobile computing device 15 may be a smartphone or tablet computer. The mobile computing device 15 can include a transceiver 25. In certain embodiments, the transceiver 25 includes multiple signal-processing components. For example, the transceiver 25 may include discrete components for amplification and/or filtering of signals in compliance with one or more wireless data transmission standards, such as GSM, WCDMA, LTE, EDGE, Wi-Fi, BLUETOOTH, and the like.

In certain embodiments, the transceiver 25 comprises a plurality of transceiver circuits, such as to accommodate operation with respect to signals conforming to one or more different wireless data-communication standards. The mobile computing device 15 further includes a processor 55. The processor 15 may include baseband circuitry, or one or more other components that are capable of providing a signal source to the transceiver 25. In certain embodiments, the transceiver 25 can include a digital to analog convertor (DAC), a user interface processor, and/or an analog to digital convertor (ADC), among possibly other things.

The transceiver 25 is electrically coupled to the processor 55, which processes signals received and/or transmitted by one or more antennas (e.g., 17, 19). Such functions may include, for example, signal modulation, encoding, radio frequency shifting, or other function. The processor 55 may operate in conjunction with a real-time operating system in order to accommodate timing-dependant functionality.

The processor 55 is connected, either directly or indirectly, to a memory module 45, which contains one or more volatile and/or non-volatile memory/data storage, devices or media. Examples of types of storage devices that may be included in the memory module 45 include Flash memory, such as NAND Flash, DDR SDRAM, Mobile DDR SRAM, or any other suitable type of memory, including magnetic media, such as a hard disk drive. Furthermore, the amount of storage included in memory module 45 may vary based on one or more conditions, factors, or design preferences. For example, memory module 45 may contain approximately 256 MB, or any other suitable amount, such as 1 GB or more. The amount of memory included in mobile computing device 15 may depend on factors such as, for example, cost, physical space allocation, processing speed, etc.

The mobile computing device 15 includes a power management module 65. The power management module 65 includes, among possibly other things, a battery or other power source. For example, power management module may include one or more lithium-ion batteries. In addition, the power management module 65 may include a controller module for management of power flow from the power source to one or more regions of the mobile computing device 15. Although the power management module 65 may be described herein as including a power source in addition to a power management controller, the terms “power source” and “power management,” as used herein, may refer to either power provision, power management, or both, or any other power-related device or functionality.

The mobile computing device 15 may include one or more audio components 75. Example components may include one or more speakers, earpieces, headset jacks, and/or other audio components. Furthermore, the audio component module 75 may include audio compression and/or decompression circuitry (i.e., “codec”). An audio codec may be included for encoding signals for transmission, storage or encryption, or for decoding for playback or editing, among possibly other things.

The mobile computing device 15 includes connectivity circuitry 35 comprising one or more devices for use in receipt and/or processing of data from one or more outside sources. To such end, the connectivity circuitry 35 may be connected to one or more antennas 19. For example, connectivity circuitry 35 may include one or more power amplifier devices, each of which is connected to an antenna. Antenna 19 may be used for data communication in compliance with one or more communication protocols, such as Wi-Fi (i.e., compliant with one or more of the IEEE 802.11 family of standards) or BLUETOOTH, for example. Among possibly other things, the connectivity circuitry 35 may include a Global Positioning System (GPS) receiver, as shown.

The connectivity circuitry 35 may include one or more other communication portals or devices. For example, the mobile computing device 15 may include physical slots, or ports, for engaging with Universal Serial Bus (USB), Mini USB, Micro USB, Secure Digital (SD), miniSD, microSD, subscriber identification module (SIM), or other types of devices through a data-communication channel.

The mobile computing device 15 includes one or more additional components 85. Examples of such components may include a display, such as an LCD display. The display may be a touchscreen display. Furthermore, the mobile computing device 15 may include a display controller, which may be separate from, or integrated with, the processor 55. Other example components that may be included in the mobile computing device 15 may include one or more cameras (e.g., cameras having 2 MP, 3.2, MP, 5 MP, or other resolution), compasses, accelerometers, or other functional devices.

The components described above in connection with FIG. 3A and mobile computing device 15 are provided as examples, and are non-limiting. Moreover, the various illustrated components may be combined into fewer components, or separated into additional components. For example, processor 55 can be at least partially combined with the transceiver 25. As another example, the transceiver 25 can be split into separate receiver and transmitter portions.

FIG. 3B illustrates a block diagram representing an embodiment of a mobile device associated with an operator of an FHV. The FHV operator device 300 may include software, such as a downloadable software application, as discussed above with respect to FIG. 1. The FHV operator device may include, among other things, a user-interface 390 that enables FHV operators to perform one or more of the following activities: locate a consumer requesting transportation services; follow a route to the consumer; start/stop the FHV trip while the passenger is situated in the vehicle; see the real-time and/or final fare; and confirm that payment has been made when the FHV trip is complete. The FHV operator user-interface 390 may enable communication with the trip manager 320 to start/stop trip processing and obtain data, such as fare and other charges.

The device 300 may include a trip timer module 310, which may include a software-based timer that starts and stops in connection with the FHV operator starting and stopping FHV trips when transporting passengers. For example, the device 300 may include start/stop button(s), such as mechanical buttons disposed on the device or touch-screen display buttons provided as part of a user interface. When a user presses the start/stop button(s), the trip timer may receive messages to coordinate starting and stopping of the software-based timer in order to record the FHV trip duration. The system may use trip timer data as a secondary calculation to validate the calculation of real-time and final fares.

In certain embodiments, the mobile device 300 includes a GPS module 350 which may provide functionality for receiving GPS signals and calculating GPS coordinates based on such signals. The GPS signals may be received via one or more antennas and signal processing circuitry. The GPS module 350 may be configured to calculate GPS coordinates in response to receiving a message from the user interface module 390 in conjunction with a user pressing the start button. The GPS module 350 may periodically collect GPS coordinates and send the information to the server interface 360, which forwards the information to the remote FHV management server.

The mobile device 300 further includes a trip manager module 320. In certain embodiments, the trip manager module receives commands from the user-interface 390 to start and/or stop collection and processing of data for FHV trips. When dedicated by the user interface 390, the trip manager 320 may send command messages to local and system-wide software modules to collect mileage, GPS coordinates and start/stop times to enable the system to calculate fares based on trip distance and/or trip duration.

In certain embodiments, the FHV operator device 300 includes an OBD device interface 330, which may enable the vehicle operator device to communicate bi-directionally with the OBD device. The vehicle operator device 300 may send start and stop messages to the OBD device to trigger the collection of OBD data from the OBD port and starting and stopping of the timer on the OBD device, such as a real-time clock or software-based timer.

The mobile device 300 may further include a server interface 360 configured to enable communication with server-side software to obtain real-time, final fare, and/or additional charge data. In addition to standard operation data, the server interface 360 may also receive system information, such as: current jurisdiction, status information, and notifications. The FHV operator device may use the server interface 360 to send start/stop trip messages, trip ID, vehicle operator ID, OBD ID, or other information to the server. The server can use such information to coordinate system-wide collection of trip distance and trip elapsed time to calculate the fare for the trip.

The FHV operator device 300 may further include a passenger device interface 370 to facilitate communication with a mobile-based passenger application to coordinate the start and stop of an FHV trip. In addition, the FHV operator device 300 may send the trip ID, vehicle operator ID and OBD ID to the passenger device to provide service provider information for safety and problem resolution.

FIG. 3C illustrates an embodiment of a user interface of an FHV operator application. In certain embodiments, the FHV operator device includes a display on which the user interface 300C may be displayed. As discussed above, such electronic display may be a component of a smartphone or tablet computer to which the FHV operator has access. In certain embodiments, the electronic display is integrated with an entertainment/media module of the vehicle, wherein the display is visible to the FHV operator. For example, such a display may be integrated with a dashboard or other component of the vehicle's interior.

The user interface 300C may be configured to display to the user an indication that the FHV operator device is in the process of pairing with, or connecting to, the vehicle's OBD device. Such pairing may occur, for example, when an FHV driver enters the vehicle, or when the vehicle is turned on, wherein the FHV operator device is disposed within a certain radius of the OBD device. For example, when an FHV operator enters the FHV and starts the engine and/or electrical system of the FHV, the FHV operator device may automatically pair with the FHV's OBD device. In certain embodiments, pairing of the FHV operator device with the OBD device may be initiated manually by the FHV operator, or other individual or system. For example, in certain embodiments, the FHV operator user interface provides a button or other mechanism, such as a touchscreen icon, by which the FHV operator may initiate pairing. Pairing of the FHV operator device with the FHV's OBD device may indicate the beginning of a working shift of the FHV operator. As an alternative to pairing through network connection, an embodiment of a pairing algorithm for the OBD device and FHV operator device can be based on node proximity through GPS coordinates.

In certain embodiments, the pairing between the FHV operator device and the OBD device begins with the OBD device broadcasting an application discovery announcement message over a local area network (LAN), which is received by the FHV operator device. The FHV operator may subsequently, or prior to that time, launch a software application on the FHV operator device having one more features described herein. In certain embodiments, when the FHV operator device executes a startup sequence, it may broadcast an application discovery announcement message over the LAN for the OBD device to receive. Upon receipt by the OBD device, the OBD device may send an acknowledgment response message back to the FHV operator device, after which pairing is completed. FIG. 3D illustrates a user interface 300D of the FHV operator device that includes an indication to the FHV operator that device pairing has been completed. In certain embodiments, the FHV operator device is configured to pair with a passenger mobile device. Once pairing successfully completes, a bond will have been formed between the two devices, enabling those two devices to connect to each other in the future without requiring the pairing process in order to confirm the identity of the devices. In certain embodiments, the bonding relationship is automatically or manually broken after a period of time. Such pairing may be performed in place of, or in addition to, pairing between the FHV operator device and the OBD device.

As discussed above, the FHV operator device may be a smartphone, tablet computer, or other mobile computing device. In certain embodiments, the FHV operator device includes, or is physically coupled to, a mounting structure, wherein the mounting structure holds the device in a particular physical arrangement. Such a mounting device may be, for example, connected to or disposed on a component of the interior of the FHV, such as a dashboard, steering wheel, seat structure, ceiling, or other structure.

FIG. 3E illustrates an embodiment of a user interface 300E of an FHV operator device including a map view having one or more icons displayed thereon. When a passenger, using a mobile application, electronically hails an FHV in an area of operation of the FHV operator, an icon may appear on the map interface 300E showing a location the passenger. For example, as shown in the figure, the user interface 300E may include one or more icons having characters or other symbols associated therewith indicating the location of the consumer. The map display 300E may further include an icon indicating a current location of the FHV. In certain embodiments, the map of user interface 300E may be centered or positioned around the location of the FHV. In certain embodiments the user interface 300e is configured to show legal or authorized locations within the jurisdiction where the FHV is permitted to pick up the passenger.

In certain embodiments, the user interface 300E may include a timeline feature 312. The timeline feature 312 may allow for selection by the user of the time period for viewing consumer activity. For example, an FHV operator may wish to see consumer activity in a particular area at a particular date or time. In certain embodiments, by sliding a slidable feature of the timeline 312 from left to right, or vice versa, the user may alter the display to show a period in time at which historical indicator objects were recorded prior to the current time. Therefore, the slide bar feature 312 may enable the driver to dynamically select the timeframe of the indicator objects displayed within the map view 300E. Therefore, the user interface 300E may enable an FHV operator to view real-time demand and historical demand for transportation services. Such information may be useful in guiding the operator's, or fleet owner's, decision of where to seek passengers. Past data may be stored by a remote server and accessed on demand through the FHV operator device application. In certain embodiments, the timeline feature allows for viewing of current, predicted future, and/or past activity concurrently. The software application of the FHV operator device may utilize one or more third-party map applications, such as, for example, Google Maps.

The user interface 300E may further include a button or mechanism 313 that enables the operator of the FHV to accept a request for transportation services. For example, in certain embodiments, when one or more passengers request transportation services, such passenger or passengers may be represented on the user interface 300E by icons, such as the illustrated icon 311. The user interface 300E may enable a driver to accept or respond to a consumer's request. In certain embodiments, a system includes logic for determining which among a group of FHV drivers to allow to respond to a request at a given time. For example, the system may determine which operator or operators to offer the request to based on distance from the requesting consumer, route time between the operator and the consumer, timing of acceptance by the operator, and/or other factors. In certain embodiments, a single FHV operator is selected to offer the consumer request at a given time, such that multiple FHV operators are not allowed to accept a single pending request.

FIG. 3F illustrates a user interface 300F of an FHV operator device application. For example, the user interface 300F may be presented to an FHV operator after the operator has picked up a passenger. When a passenger enters the FHV, the operator may be provided a mechanism for indicating that a trip associated with the passenger has begun. For example, as shown in FIG. 3F, the interface 300F may include a button 321 or other icon which may be selected by the operator indicating that the operator has been hired by the passenger. The operator device may proceed to collect trip distance and/or time data as well as possibly other trip-related information for use in fare calculation. For example, such information may be acquired from the OBD device or from one or more sensors or devices of the FHV operator device. In certain embodiments, trip-related information is transmitted over a network to a remote server. The server may use such information to calculate a fare, and may periodically, or continuously, transmit calculated fare values to the FHV operator device. Accordingly, user interface 300F may display the fare calculation 317, as well as additional fees or charges 318 associated trip. While certain embodiments disclosed herein describe fare calculation operations being performed at a remote server, in certain embodiments, the FHV operator device has downloaded thereon fare calculation parameters and/or algorithms, such that fare calculation may be done locally by the FHV operator device, OBD device or FHV passenger device.

Following completion of the trip, the FHV operator may request payment from the passenger, either verbally or electronically over the LAN. Once payment is received from the passenger, the FHV operator device may display a user interface 300G (FIG. 3G) which includes an indication 323 to the operator that the transaction is complete. Payment may be provided by the passenger electronically over the LAN, or in some other manner. For example, there may be, in the operator's possession or disposed within the FHV, a payment card reader, which may be communicatively coupled to the FHV operator device, either over the LAN, or over an Internet connection.

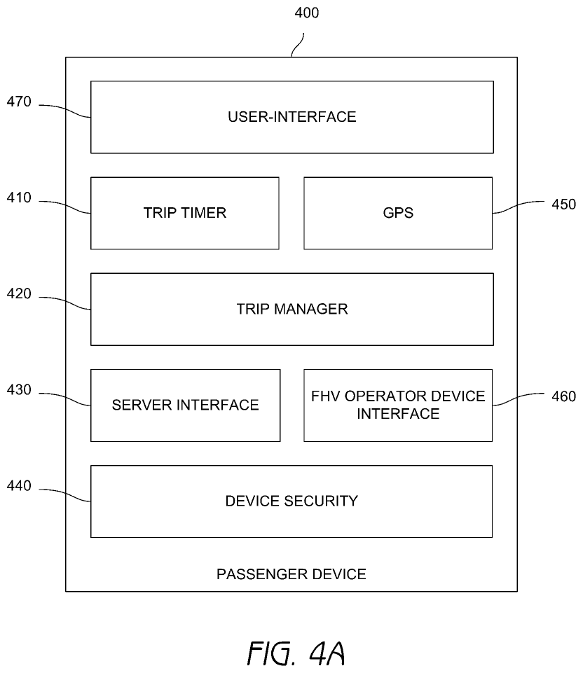

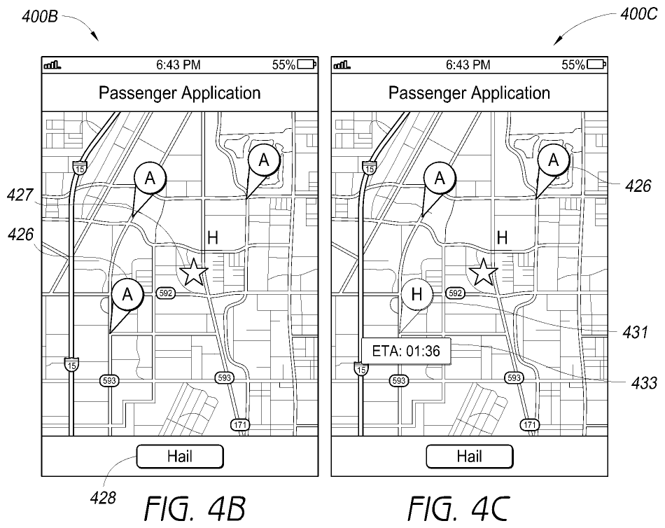

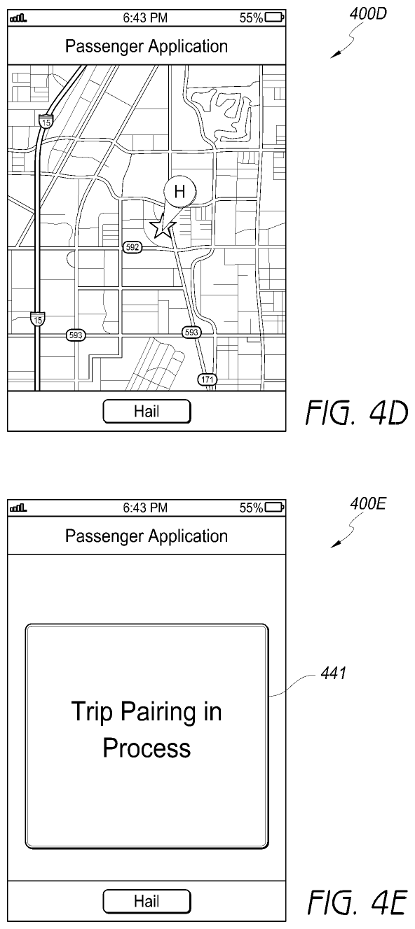

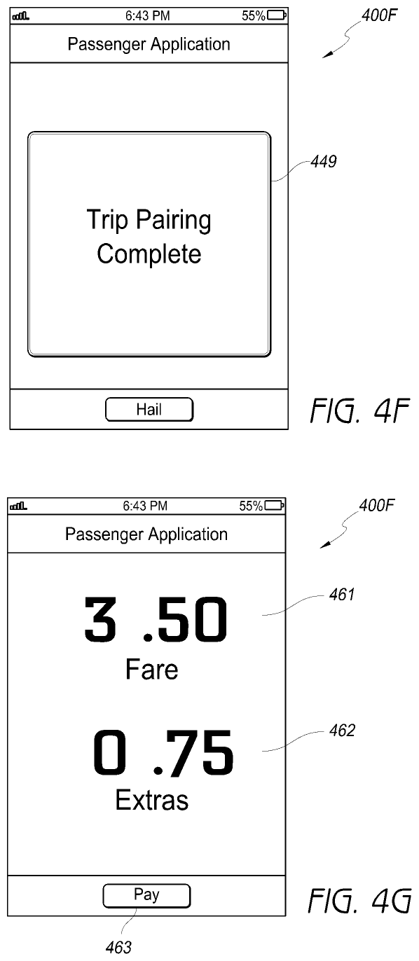

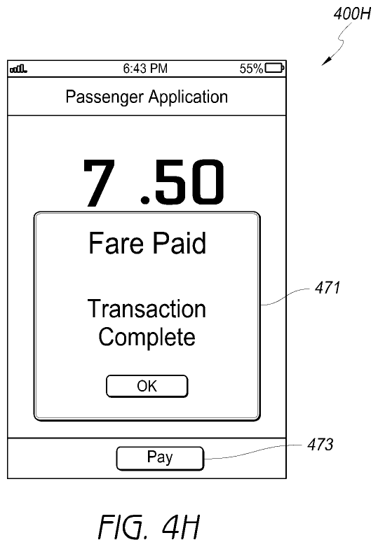

FIG. 4A illustrates a block diagram representing an embodiment of a mobile device 400 associated with a passenger, or potential passenger, of an FHV. FIG. 4 shows various software and hardware modules that may be associated with the passenger device 400. In certain embodiments, the passenger device may be used by consumers to find FHVs, remotely hail FHVs, receive transportation services, track real-time cost information, and/or pay for transportation services. Furthermore, a user interface 470 provide functionality for the passenger to remotely hail a nearby, available FHV, track the FHV to a pick-up location, see real-time fare, see the final cost for the transportation service, and/or pay. The passenger device may be any suitable mobile device, such as a smartphone (e.g., Apple iphone, Android smartphone, and the like), tablet computer (e.g., Apple iPad, Samsung Galaxy tablet, and the like), or other mobile device. In certain embodiments, the user interface 470 shows the nearest location(s) where an FHV may be able to legally or practically/conveniently stop.

The passenger device 400 may include a trip timer module 410, which is configured to receive command signals from the FHV operator device 300 for calculating the trip duration by starting/stopping the software-based timer. The trip timer module 410 may periodically or sporadically send timer information to the remote FHV management server via a server interface 430. Such timer information may be utilized by server-side software to validate one or more other fare-calculation methods implemented by the server.

The passenger device 400 may further include a GPS module 450 configured to receive command messages from the FHV operator device to start/stop distance calculation in conjunction with the start/stop of an FHV trip. The GPS module 450 may accesses a GPS receiver disposed within the passenger device 400 to obtain periodic GPS coordinates while the FHV trip is ongoing. In certain embodiments, the GPS module sends the GPS coordinates to the remote FHV management server via the server interface 430. Server-side software may use the GPS coordinates to validate the fare calculations made by one or more alternative calculation mechanisms.

The passenger device 400 includes a trip manager module 420 configured to manage, among possibly other things, historical trip data and real-time trip data during an FHV trip. The trip manager 420 may coordinate with other devices/applications/software modules in the system 100 of FIG. 1 to start and stop collection of distance and elapsed time data in coordination with the start and stop of a FHV trip. The server interface 430 may enable the passenger device 400 to communicate with the remote server to synchronize starts and stops of FHV trips, obtain real-time and final fare calculations and any status notifications pertaining to correctness of information and safety. For example, the user interface may present a display on the passenger device providing functionality for the user to input data for communication purposes.

In certain embodiments, the passenger device 400 includes an FHV operator device interface 460 that facilitates communication with the FHV operator device. Through the operator device interface 460, the passenger device receives start/stop command signals to coordinate the beginning and end of a FHV trip, which the FHV operator controls. The passenger device 400 may also use the FHV operator device interface 460 to send response messages to the FHV operator device to ensure proper coordination. For example, the passenger device may alert the FHV operator device regarding device pairing, data obtained from the OBD device, or other information, wherein the FHV operator device and/or passenger device may allow for automatic or manual confirmation that information on the devices is consistent.

The passenger device 400 may further include a device security module that enables the passenger device to securely connect and communicate with other computing nodes within the system 100. The device security module 440 may support security protocols at the media access layer by providing hardware identification like a MAC address or proprietary device ID. In addition, the device security module 440 may support networking protocols to encrypt payloads of communication packets to ensure privacy of information transmitted over local and wide-area networks. In certain embodiments, the device security module 440 supports application-level security to ensure that only authorized software can access and exchange data with the other nodes within the system.

The FHV management server described above with respect to FIG. 1 may include server-side software that facilitates interactions with OBD devices, FHV operator devices and/or passenger devices. In certain embodiments, the server-side software is a collection of software modules providing functionality that may include, but is not limited to, device security, device management, reservation/hailing, mobile payment, user security, group-user management, trip entity pairing and management, fare calculation management, meter parameter management and web application providing a user interface. In certain embodiments, the server-side software is what allows users to find an FHV, connect with the FHV operator, obtain transportation service, view the calculated fare, and pay for the transportation service.

Use of a passenger application to hail an FHV may provide improved FHV dispatch efficiency. For example, by allowing the user to view and hail vehicles using a mobile application, it may not be necessary to employ a dispatcher or other middle man to assist in executing such operations. Furthermore, information may be made available to the user that traditionally may not have been available, such as notification of acceptance by a particular FHV and location, distance, and/or estimated time of arrival of the FHV.

FIG. 4B illustrates an embodiment of an exemplary user interface 400B that may be displayed on a passenger device. For example, the user interface 400B may be viewable by a user wishing to request transportation services from his or her mobile device. As shown, the user interface 400B may include a map view having one or more icons illustrated thereon. For example, icons 426, 427 may be shown on the map to represent available FHV's in the vicinity (a capital letter ‘A’ is used in the drawings). In certain embodiments, located FHV's may be represented by an icon indicating that the FHV is available for hire. As shown in FIG. 4B, an ‘A’, or other letter or symbol, may indicate that a for her vehicle is available for hire.

The user interface 400B may further display an icon or symbol indicating the location of the user. For example, location of the user may be derived through GPS or other location determination circuitry that is part of the passenger device. The may can show locations nearby where the FHV can pick passengers up. As shown in FIG. 4B, the icon representing the current location of the user may be a star 427 or other symbol. The user interface 400B may further include a button or other mechanism for communicating a request for transportation services. As shown in the figure, such a button for 28 may be labeled ‘Hail,’ or with some other term or terms.

In certain embodiments, the user interface 400B may provide functionality for a user to view details relating to one or more FHV's or FHV operators. For example, in certain embodiments, a user may reveal a pop-up or other menu containing driver rating and/or other details (for example, type of vehicle, capacity of vehicle, fees, company affiliation, estimated time of arrival, and the like) by clicking on or touching an icon representing an FHV. In certain embodiments, the user interface 400B provides functionality for a user to view details associated with various FHV operators and designate a specific FHV to hail. This could be done, for example, by touching the icon on the screen or the location where the passenger wants to be picked up. If a specific FHV is hailed, the system may present such transportation request to the hailed FHV and request acceptance of the transportation request.

The user interface 400B may provide functionality for the user to input pick-up and/or destination location information. As described above, the user may press a ‘hail’ button 428, wherein the current location of the user is designated by the dispatch system as the pick-up location. Alternatively, the user may be able to input a designated pick-up location. For example, a transportation service provider may only service particular pick-up locations, such as bus stops, train stations, and the like. In certain embodiments, when the user presses the ‘hail’ button, it is determined the closed available pick-up location, wherein the FHV is dispatched to that location for pick-up. In addition, the user may enter destination information prior to being picked up, or prior to dispatch of the FHV, using the passenger application. Such information may be used by the dispatch system to intelligently allocate FHVs to improve dispatch efficiency.

In certain embodiments, dispatch operations are carried out by a base operator offering one or more taxi-related services, such as, for example, insurance, vehicle maintenance, advertising, and the like. In certain embodiments, dispatch operations are performed by a central server or agent of the central server.

FIG. 4C illustrates an embodiment of the user interface for a passenger device application. In certain embodiments, the system is configured to receive a request from the user for transportation services and forward that request to a dispatcher. The dispatcher may be part of a central server or may be a separate third-party entity. In certain embodiments, the central server maintains information indicating what dispatchers are licensed to operate in relevant jurisdictions. Therefore, the system may allow for mobile device dispatch functionality while ensuring that any dispatcher who services a request is authorized to do so. Because the information maintained by the central server may be transparent to regulatory entities, such entities can be confident that dispatch operations are authorized.

In certain embodiments, a system as described herein is configured to optimize dispatch operations within a fleet, between fleets, between zones/jurisdictions, and/or between regulatory bodies. If the system maintains real-time or historical data related to FHV activity, it may be situated to use an efficiency model to allocate resources for FHV dispatching. The dispatch logic may operate with respect to designated pick-up locations, wherein proximity to such locations may at least partially determine which vehicle is dispatched by the system. In certain embodiments, dispatch is performed automatically. The optimization functionality may implement standard linear optimization programming, for example. In certain embodiments, the system allocates inter-fleet or inter/jurisdictional FHV resources based on particular needs of a jurisdiction, as demonstrated by the maintained FHV activity data. Therefore, such systems may improve efficiency of FHV dispatch operations.

The user interface 400C may be presented to a user following a request by the user for transportation services, such as by pressing a hail button, as described above. The user interface 400C may indicate the FHV object in the user interface representing the FHV that has accepted the request for transportation services. For example, as shown in FIG. 4C, such icon may be labeled with one or more letters or symbols indicating that the FHV has been hired, such as an ‘H,’ as shown. Additional information may also be shown on the user interface 400C. For example, a window or other display feature may provide estimated time of arrival (ETA), distance, fare-related, or other information. FIG. 4D illustrates a user interface 400D indicating that a hailed FHV has arrived at or near the passenger pickup location.

FIG. 4E is an illustration of a user interface 400E that may be displayed on a passenger device after the passenger has entered or approached the FHV. Upon entering or coming within a certain radius of the FHV, a device pairing process may be initiated between the passenger device and the FHV's OBD device, and/or FHV operator device. In certain embodiments, when the passenger device comes within a certain radius of the OBD device, the passenger device may transmit an application discovery broadcast message over an LAN. In response, the OBD device and/or FHV operator device may receive the message and respond with an acknowledgment message to the passenger device. In certain embodiments, the user interface 400E provides a notification message to the passenger indicating that the application is in the process of pairing with one or more of the OBD device and the FHV operator device. Once pairing between devices has been completed, the user interface 400F illustrated in FIG. 4F may provide a notification message to the passenger indicating that device pairing was successful. Completion of such pairing may indicate the beginning of a trip. In an embodiment, a trip pairing algorithm may be based on node proximity through GPS coordinates.

FIG. 4G illustrates an embodiment of a user interface 400G that may be displayed on a passenger device during transportation of the passenger in an FHV. During a trip, the passenger device may collect trip distance and/or time data. For example, the passenger device may collect such information from the FHV's OBD device over the paired connection. In certain embodiments, information is acquired by the passenger device from the FHV operator device, or from one or more sensors or devices of the passenger device, such as a GPS receiver module and/or clock device. The passenger device may send such collected information to a remote server for processing. For example, in certain embodiments, a remote server uses information acquired from the passenger device to calculate taxi fare values. Such fare calculations may be periodically or continuously transmitted by the server to the passenger device, wherein the user interface 400G displays information relating to such fare calculation. In certain embodiments, the user interface 400G displays a real-time fare 461, as well as additional fees or charges 462 associated with the trip.

Certain embodiments provide a user interface 400H for displaying to the passenger at the end of the trip, that is, after an indication has been made that the passengers desired destination has been reached. Such indication may be provided, for example, by the FHV operator and/or passenger by pressing or touching a button indicating the end of the trip, or by the processing of information indicating that the destination has been reached, such as speed, time, acceleration, location, or other information. For example, in an embodiment, an FHV operator presses a ‘timer off’ button indicating the arrival of the FHV at its destination. The passenger's device receives notification over a paired connection, after which the passenger's device displays the final fare. The user interface 400H may provide functionality for the user to make a payment in association with the completed trip. For example, the passenger device may be configured to initiate a payment process upon request by the passenger to do so, such as by pressing a pay button 463. In certain embodiments, the user interface 400H provides the user the ability to input payment information, such as payment card information, bank account information, or other information with which payment may be made. Certain embodiments provide a mechanism by which a passenger may indicate an intention to pay for transportation services using cash or other means. For example, after indicating an intent to pay a fare with cash, an FHV operator may be notified of such intention, and may execute the cash transaction with the passenger. In certain embodiments, the passenger is permitted to pay for services using a payment card reader that is configured to communicate directly or indirectly with one or more of the FHV operator device, passenger device, and remote server.

In certain embodiments, a consumer can establish a payment account for use in paying for transportation services. For example, a consumer may submit bank account or credit card information in an online profile authorizing a central server to withdraw funds from the account. The consumer may alternatively establish a payment account in which funds are contributed in advance to the account. For example, the account may be replenished from time to time by the consumer, thereby maintaining adequate funds for anticipated transportation service consumption. In certain embodiments, the consumer's account is automatically debited for transportation fees upon completion of a trip.

In certain embodiments, the user interface 400H is presented to the passenger after the FHV operator device sends a stop-trip message to the OBD device, passenger device, and/or remote server. After receiving the stop-trip message, the server may send a final fare value and associated additional costs to the FHV operator device and/or passenger device. The FHV operator device and/or passenger device may then display the final fare and costs for viewing. In certain embodiments, the passenger device sends a transaction message to the server, or a mobile payment module of the server, directing the server to start the payment process. In certain embodiments, the server debits an account of the passenger and credits an account of the operator or fleet owner an amount related to the final fare calculation. Notification may then be provided to the passenger via the passenger device indicating that the transaction is complete

FIG. 5A illustrates a block diagram representing an embodiment of a FHV management server 500. The various modules shown in the figure represent various hardware and software modules that may be present as part of the server 500. The server 500 may include a web application module 550 that enables various users to access the server-side software for group and user account management, management of remote devices connecting to the server-side software, management of fare calculation engines, management of meter parameters, and/or reporting and monitoring of server-side software and system operations. The web application may support user roles and display only the relevant and permitted views to each user type and group. The web application 550 may further provide user workflows that enable personnel employed by fleet operators and regulatory agencies to streamline and automate processes.

The server system 500 may include a device security module 505. The device security module 505 may be configured to accept or reject access from remote devices. For example, it may support media access layer security by interacting with remote devices during connection request to obtain and verify unique hardware ID. In certain embodiments, the device security module 505 validates provided hardware IDs against a known list of approved hardware IDs. If the hardware ID is approved, the device security module 505 may grant the requesting device access at the media access level and log the incident; otherwise, it may reject the connection request and log the incident. Once the requesting device obtains media access, the device security module 505 may coordinate with the requesting device to establish network security for data encryption of packet payloads. Both the device security module 505 and the device security module of the requesting device may be configured to follow a handshaking procedure to establish encrypted bi-directional communication by using private-public key exchange. Once the keys are in place at both the server and mobile device, the sending node may encrypt data with the public key and receiving node may decrypt with the private key. Once the device security module 505 establishes a secure network connection with the requesting device, the device security software may establish application-level security by requesting security credentials from the application running on the mobile device. The device security module 505 may validate the credentials and provide application access if the credentials are valid; otherwise, the device security module may deny access.

The server 500 may further include a device management module 510 configured to enable fleet operators and regulatory agencies to manage remote devices. For example, with respect to regulatory agencies, the device management module 510 may enable authorized agency personnel to remotely access OBD devices to provision, configure, update and/or monitor the devices. In addition, agency personnel may be able to configure the server-side software to define jurisdiction(s), geographic boundaries, date and time of operation, fare calculation engine and meter parameter for the OBD device. When the OBD device is connected to the FHV and maintains the FHV VIN, agencies may have fine-grained and real-time management capabilities with respect to the FHV. The device management module 510 may enable agencies to enable/disable OBD devices to dynamically regulate the available FHVs operating within a jurisdiction and/or geography to match FHV supply and consumer demand.

The device management module 510 may enable fleet managers to monitor OBD devices and vehicle operator devices to provision, configure, update and/or monitor the devices. For fleet managers, the device management module of the server-side software may enable configuration of both the OBD device and vehicle operator device to accommodate their business needs. In addition, the device management module 510 may enable the fleet operators to enable/disable OBD devices to dynamically manage FHVs within the fleet. In addition, fleet operators may have the capability to monitor the driving behavior (for example, incident history, consumer evaluations, and the like) of the FHV operator.

The server 500 may further include a reservation/hailing module, which is a real-time monitoring and dispatching engine. The reservation/hailing module 520 may be configured to monitor OBD devices, vehicle operator devices and passenger devices to determine FHV availability and passenger demand. When a consumer hails using a passenger application running on their mobile device, the reservation/hailing module 520 may initiate a search algorithm to determine available FHVs within an ever-increasing search radius to determine an appropriate or ideal FHV based on proximity, time, type of FHV, cost, and/or other factors. The reservation/hailing module 520 may send a prioritized list (e.g., default, nearest and lowest price) of available FHV. The reservation and hailing module 520 may continuously monitor the available/hired status of one or more FHVs, as well as their location and, if hired, trip destination.

The mobile payment module 530 of the server-side software may enable consumers to pay for transportation services over a network, such as with their mobile devices. Furthermore, the FHV operator and fleet operators may be able to receive payment for delivered services from the payment module 530. Upon completion of an FHV trip, the mobile payment module 530 may receive a message from the vehicle operator device and obtain the final fare for the specific FHV trip. The module 530 may debit the passenger's account and credit the fleet operator's account and/or directly credit the vehicle operator's account.

The mobile payment module 530 of the server-side software may enable consumers to establish a mobile payment account online, such as via the passenger application. During initial use and daily use, the mobile payment module 530 may enable consumers to maintain credit card information that will be used to pay for transportation services, such as part of a user profile.

The mobile payment module 530 of the server-side software may enable fleet operators and consumers to establish accounts-receivable (AR) accounts via the web application interface of the server-side software. For example, the mobile payment module 530 may enable operators to submit routing number and bank account number so that the mobile payment module can credit the AR account with payment.

The mobile payment module 530 of the server-side software may enable FHV operators to establish a payment account via the FHV operator device running on their mobile device. The mobile payment module 530 may further enable FHV operators to submit credit card information so that the mobile payment module can credit the credit card account with payment.

The fare calculation management module of the server-side software enables regulatory agencies to upload, enable/disable and monitor multiple fare calculation engines. The fare calculation management module enables agencies to rapidly update, test and deploy fare calculation engines. When deployed, agencies can immediately and universally roll-out a new calculation engines by jurisdiction. In addition, the fare calculation management enables agencies to rollback to any previously uploaded fare calculation engine for real-time, dynamic management.

The fare calculation engine 540 may be configured to enable the system to utilize up-to-date approved fare calculation algorithms as dictated by the regulatory agency for a jurisdiction. The fare calculation management module 540 may follow a roll-out rule that determines any ongoing FHV trip will be subject to the previous fare calculation algorithm and upon completion of that trip, the fare will be calculated with the previous calculation algorithm. For new FHV trips, the trips will be subject to the newly uploaded, approved fare calculation algorithm, and when the trip concludes, the fare may be calculated with the new calculation algorithm.

The server may provide a user interface for use by regulatory agencies and/or FHV fleet owners to access information related to FHV activity within particular jurisdictions. Such a user interface may be browser-based, and may be accessible through Internet navigation, and may require user ID, password, and/or other security information to be input to the server via the interface in order for access to server stored contents to be granted. With respect regulatory agencies, an agent may log into the system over the Internet or other network connection. The user interface may provide information relating to FHV trips, OBD devices, FHV operators, and other information related to regulation and management of FHV activity with in a jurisdiction in which the regulatory agency has authority. In certain embodiments, the user interface allows access by regulatory agency only to information relevant to such agencies jurisdiction.

The user interface may allow for the regulatory agency to set up, enable, provision, monitor, update, or otherwise modify or configure information stored at the server. For example, a regulatory agency may use the user interface to input fare calculation parameters and associate such parameters with zones and/or jurisdictions in the system. Using such information, the server may be configured to perform fare calculations using the information provided by a regulatory agency, as well as location-related information associated with an FHV trip forward the fare is being calculated. Such functionality may simplify the process of modifying rate calculation parameters for regulatory agency for example, by inputting such parameters over a network link, it may not be necessary for a regulatory agency to physically access, program, and seal an onboard device of an FHV in order to permit such device to operate within particular zone or jurisdiction. Furthermore, in certain embodiments, authority may be given by a regulatory agency to an FHV operator to operate with in multiple jurisdictions, such as contiguous jurisdictions. In such embodiments, the system may be configured to allow the FHV operator to pass between regulatory zones or jurisdictions, wherein fare calculations associated with the FHV are made according to the relevant zone or jurisdictions with different regulations by the server without physically accessing the FHV or onboard device. Furthermore, the user interface may allow for regulatory agencies to view information that would not otherwise be available to them, such as details relating to FHV activity, as detailed below. With respect to fleet owners, the server user interface may display data only relevant to the fleet owner's particular fleet. Furthermore, in certain embodiments, fleet owner users of the user interface may not have access to make changes to parameters regulated by regulatory agencies.

The server user interface may allow for streamlined medallion application procedures, thereby improving efficiency of regulatory agencies and medallion applicants. For example, the user interface may provide a mechanism by which applicants may submit online applications to a regulatory agency, wherein the regulatory agency is able to review and/or grant authorization over an online server. Therefore, the need for physical exchange of hardware and other inefficiencies associated with traditional medallion procedures may be reduced or eliminated. The user interface may further allow for online submission and/or processing of payments associated with medallion ownership, such as medallion purchase amounts and possibly fees/fines levied by the regulatory agency on FHV operators or fleet owners.

Server-side software may be open platform software, including external programming interfaces that allow the software to function in other ways than the original programmer intended, without requiring modification of the source code. Using an application programming interface (API), a third-party may be able to integrate with the platform to add functionality. As an open platform, a developer may be able to add features or functionality not completed by the platform vendor.

FIG. 5B illustrates an embodiment of a user interface 500B that may be provided using a web-based application. In certain embodiments, the user interface 500B provides different views for presentation of information to users. For example, the user interface 500B may provide tabs 503 or other selection mechanisms by which a user may select a particular view in which to view information. The user interface 500B may correspond to a trip-based presentation of information. As shown, FHV activity information may be presented on a trip-by-trip basis, wherein individual trips, or groups of trips, are listed along with accompanying information related to the trip or trips. In the user interface 500B, trip information may include, for example, trip ID number, OBD ID number, driver ID number, trip start time, zone, trip status, pickup address or location, drop-off address or location, trip duration, fare calculation, or other information. In certain embodiments, trips are listed in chronological order. Furthermore, the order of trips in the listing may be sorted or filtered by entering search terms in a search box 501, date information in a date box 502, or by selecting one or more categories of information by which to filter or order the displayed trip information. In the search box 501, a user may be able to search for trips based on various parameters, such as trip ID number, OBD ID number, driver ID number, etc.

In certain embodiments, users may obtain additional information regarding a trip by selecting a line item within a listing of trips, or by otherwise identifying a particular trip or piece of information associated with the trip. For example, the user interface may allow for selection of a trip or piece of information, and may display additional information about such trip or information in response to the selection. As shown in FIG. 5B, the user interface 500B may include a text box or other information presentation mechanism in which additional information may be presented the user. Furthermore, upon selection of a trip or piece of information, such line item or information may be highlighted to indicate that the detailed information presented is related to the highlighted content.

The information available in the user interface 500B may be useful to regulatory agencies for the purposes of generating statistical reports or performing analysis of FHV activity within the agency's jurisdiction. For example, a user may wish to calculate or view average fare and/or distance values associated with trips in the user's jurisdiction. The information provided in the user interface 500B may allow access to regulatory agencies to information that they historically have not had. Therefore, certain embodiments disclosed herein may simplify and/or expedite operations of regulatory agencies with respect to FHV activity.

FIG. 5C provides an illustration of an embodiment of a user interface 500C that presents information related to OBD devices operating with in a particular jurisdiction. As shown, FHV activity information may be presented on a device-by-device basis, such information including, for example, OBD ID number, name of the company that owns the OBD device, zone or zones of operation of the OBD device, status of the OBD device, information related to incidents in which the OBD device was involved, and/or other information. The user interface 500C may enable users to search for specific data in the search box or other tool, such as by specific OBD ID number, owner, zone, and/or other information. Furthermore, user interface 500C may allow for users to obtain more detailed information relating to a specific OBD device when a user selects a line item or otherwise indicates a desire to view detailed information relating to an OBD ID or other piece of information. Additional information may be displayed in a detailed status box 549 or other display tool.

The user interface 500C may allow for regulatory agency users to modify certain information relating to OBD devices. For example, the user may be able to set an activation status value, such as an indication that a particular OBD device or devices are enabled or disabled. For example, a user may be able to access such information by triggering a pull-down menu as a mechanism for inputting modifications. In addition, the user interface 500C may allow for setting a zone or zones in which an OBD device is authorized to operate by the regulatory agency. In certain embodiments, the server may allow for a regulatory agency to authorize an OBD device to operate within multiple jurisdictions, wherein the server is configured to perform fare calculations relating to the OBD devices operation in such zones based on parameters inputted by the regulatory agency. For example, the server may determine which among a group of authorized zones an OBD device is operating at a given time and access appropriate fare calculation parameters based on such determination.

FIG. 5D illustrates embodiment of the user interface 500D of a server-side application. The user interface 500D may correspond to a driver-based view of FHV activity information. For example, the user interface 500D may present information such as driver ID number, employer company, activation status, date of activation status setting, driver-related incidents recorded in the system, and/or other information. The user interface 500D may enable regulatory agencies to monitor and manage drivers operating within their jurisdiction. In certain embodiments, the user interface 500D enables users to search for specific items, such as by driver ID number, company name, etc. Furthermore, user interface 500D may enable users to access additional information by clicking on a line item within a list or table of drivers (i.e., FHV operators), or by indicating a desire to view such information in some other manner. In certain embodiments, detailed information regarding a particular driver or piece of information is presented in a box 577 or other display tool.

In certain embodiments, a user may be able to access additional information related to reported incidents of a driver. For example, by clicking on a value showing a number of incidents, a user may be able to access a list or box containing additional incident-related information, such as the date or nature of such incidents. Suspension information may be related to actions taken by regulatory agency or by a fleet owner. In certain embodiments user interface 500D includes information indicating whether a suspension was executed by a regulatory agency for regulation violations, or by a fleet owner. In certain embodiments, regulatory suspensions and company suspensions are viewable only to agents of the respective entities.

FIG. 5E illustrates embodiment of a user interface showing a map view having icons displayed thereon, wherein the icons represent various FHV's and/or consumers. In certain embodiments, the user interface 500 E displays a map view with hired FHV's, available FHV's, and consumers requesting transportation services, wherein each of the respective categories is represented by a different icon or object. For example, as discussed above with respect to applications on FHV operator devices, ‘H’ may indicate a vehicle that is hired, ‘A’ may indicate vehicle that is available, and a star other symbol may indicate a passenger hailing for transportation services.

In certain embodiments, the user interface 500E may provide functionality for a user to change a zoom level of the view or scroll the map should cover other regions. When users zoom in or out, the dashboard view may update the map with relevant data for the new geographical boundary represented by the zoomed-in/zoomed-out map window. When users move a cursor over a map icon within the map, the user interface 500E may present a pop-up window or other information display that contains additional information about the vehicle operator or passenger represented by the object. The user interface 500E may be configured to present real-time and historical data. For example, the user interface 500E may include a timeline feature 589 that a user may use to select a period of time with which the icons on the map are associated. Therefore, a regulatory agency may be able to see trends or other information related to FHV activity within their jurisdiction. The regulator may utilize such information in determining where and how FHV medallions should be utilized. In certain embodiments, systems disclosed herein provide functionality for a regulatory agency to provide instant, or expedited, authorization to FHV operators to operate in zones in which they were not previously authorized to operate. For example, such authorization may be on temporary terms, and may be granted in order to meet a particular need or demand. Such needs or demands may be identified by the regulatory agency through access to the information provided in the user interface 500E.

By allowing the regulatory agencies and fleet operators to view real-time and historical FHV activity, it may be possible to locate regions of a jurisdiction that are currently not served, or are underserved, thereby providing information that may be used in identifying expansion/relocation opportunities for FHVs. Such information may allow for analysis of statistical information relating to the location of consumers seeking transportation services, and may help identify suburban or non-metropolitan areas that may benefit from local FHV placement.

FIG. 5F illustrates an embodiment of a user interface displaying a geographical zone map layout. A regulatory agency may access such view in order to modify boundaries or other information associated with a particular zone or zones. For example, the map window 519 may include functionality for a user to designate boundaries for a zone, such as by dragging or otherwise manipulating boundary objects represented on the map. Furthermore, regulatory agencies may be able to use such view to add or delete zones from the server database for their particular jurisdiction. The user interface 500F may include buttons or other tools for selecting, by the user, zoning modification functionality. For example, the user interface 500F may include an ‘Add Zone’ button 551, an ‘Edit Zone’ button 552, and/or ‘Delete Zone’ button 553.

When a user indicates a desired to implement zone editing functionality, a user interface as illustrated in FIG. 5G may be displayed. Such an interface may enable users to manage fare calculation and meter parameter information associated with one or more zones. The user interface 500G may further enable user to create, edit, manage, and delete fare calculation algorithms and/or meter parameters. For example, within a particular zone, a particular fare calculation algorithm may be applicable in certain situations. Such algorithm may include one or more variables, as shown in FIG. 5G. A regulatory agency may utilize the user interface 500G to modify algorithms or parameters as desired in order to regulate fare calculation with in the zone. The variables and algorithm listed in FIG. 5G are provided as examples only, and different algorithms or parameters may be utilized in fare calculation management depending on relevant regulations.

Variables associated with fare calculation algorithms may include, for example, mileage rate, time rate, flagged down, or other initiation fees, toll charges, charges for dispatching services, other value-added services provided by third-party companies or other extra charges associated with particular events or locations incurred by an FHV operator or otherwise appropriately charged to the passenger. The following algorithms, or variations thereof, may serve as a basis for taxi fare calculations in Las Vegas, for example, as determined by relevant regulations with respect to various trip circumstances:
(1) Cash payment; Never on airport property

Taxi Fare=A+(B*(Distance Traveled*13))+(C*Wait Time)+(F*Distance Traveled)
(2) Cash; Entered/left airport property

Taxi Fare=A+(B*(Distance Traveled*13))+(C*Wait Time)+D+(F*Distance Traveled)
(3) Credit card; Never on airport property

Taxi Fare=A+(B*(Distance Traveled*13))+(C*Wait Time)+E+(F*Distance Traveled)

### Wherein:

A=First 1/13th Mile ($3.30)
B=Each additional 1/13th Mile ($0.20)
C=Waiting time, per hour ($30)
D=McCarran Airport Property ($1.80)
E=Credit/Debit Card Fee ($3.00)
F=Fuel Surcharge per Mile ($0.20)
Wait Time=Number of hours when the taxi is not moving, the meter is on and the passenger is out of the FHV.
Distance Traveled=Miles travelled from pick-up location to destination

As shown above, fare calculation algorithms may include fees associated with geographical areas, wherein such fees are applied when an FHV arrives at or traverses certain geographical areas during a hired trip. Example may include fees for crossing a bridge or entering a metropolitan area. Such fees may be associated with third-party toll charges, and may include additional fees on top of such fares/charges to be paid to the FHV management entity. Systems and methods disclosed herein provide for online access to, and modification of, fare calculation parameters and algorithms. Such online functionality may significantly reduce costs and/or time associated with taximeter updates. Furthermore, systems disclosed herein may allow for simplified driver/owner/regulator transactions, thereby increasing efficiency and/or transaction capacity.

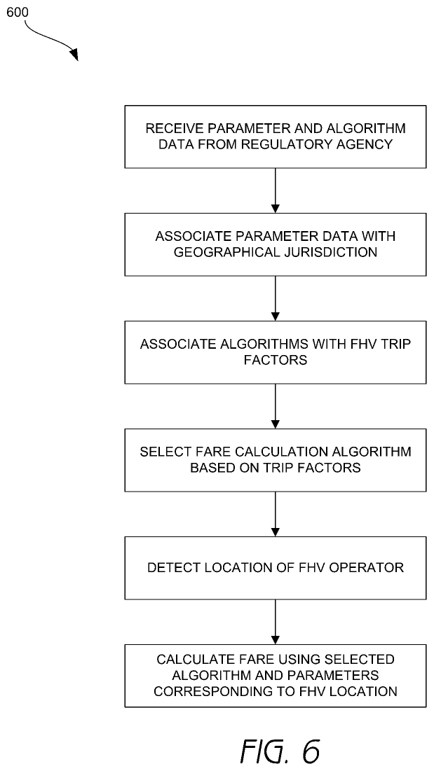

FIG. 6 provides a process for assigning, by a FHV management server, a fare calculation algorithm and associated set of meter parameters for a particular jurisdiction or trip. The process 600 includes detecting the location of an FHV operator and passenger using GPS coordinates obtained from one or more of the FHV operator device and passenger device. The process may at least partially rely on location-based services to determine the jurisdiction within which the FHV operator and passenger are located, and determine the appropriate fare calculation engine and meter parameters to calculate the fare.

The process may include providing a user interface for data input by regulatory agencies. Such data may include meter parameters, wherein inputting such data allows for regulatory agencies to at least partially manage a fare calculation engine, including algorithm/parameter availability and selection. Parameters may be input with respect to multiple jurisdictions. In certain embodiments, user interfaces are provided by one or more web applications, which enable authorized employees or individuals to securely and remotely access the fare calculation data store. Users may thereby be permitted to upload, configure, enable/disable and monitor fare calculation engine operations.

A user interface may also be provided for fleet operators to manage OBD devices and FHV operator devices. For example, the system may enable authorized users to provision, configure, monitor and/or update system modules, such as device-embedded software of one or more OBD devices, or vehicle operator/passenger mobile devices. In certain embodiments, the user interface is provided through a web application.

As described above, systems and methods disclosed herein may simplify or streamline taximeter operations. By utilizing cloud-based fare calculation, it may be possible to engage in FHV operations without the use of a traditional taximeter. Due to costs associated with manufacturing and maintaining traditional taximeters, systems disclosed herein may provide for significant monetary savings in addition to time savings.

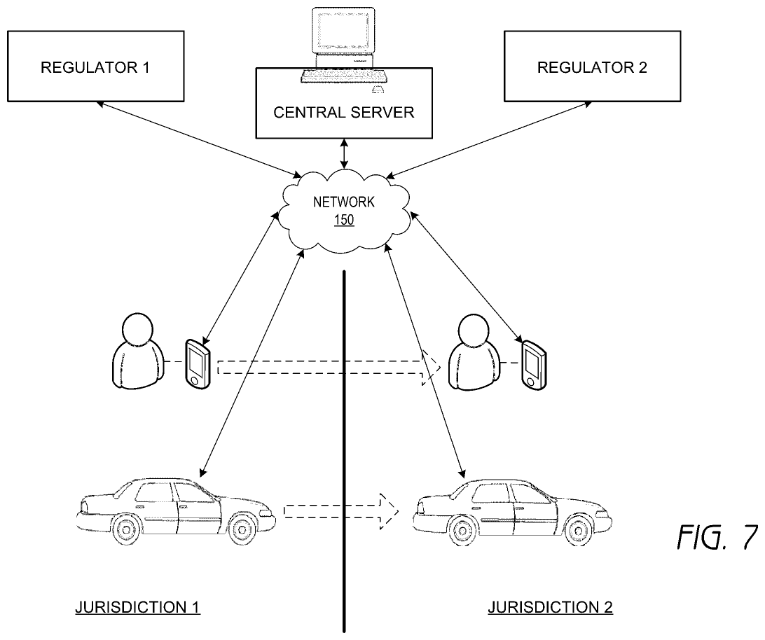

FIG. 7 illustrates an embodiment of a system including a central server configured to service FHV operations in multiple jurisdictions and/or zones. The figure shows two jurisdictions, jurisdiction 1 and jurisdiction 2. Jurisdiction 1 and jurisdiction 2 may correspond to geographical regulatory jurisdictions for FHV activity. In certain embodiments, FHV data associated with multiple jurisdictions is maintained by a single central server. For security purposes, the central server may be partitioned or divided in such a manner to prevent co-mingling of data, or unauthorized access.

The figure illustrates 2 regulatory entities, regulator 1 and regulator 2. In certain embodiments, the central server may store fare calculation algorithm and parameter information relating to regulations of both regulator 1 and regulator 2. As described above, the system may allow for regulatory entities to input regulatory parameters or other information to the central server over a network, such as the Internet.

FIG. 7 further illustrates a consumer having a mobile computing device. In certain embodiments, the user may use the mobile computing device to request transportation services through the central server over a network. The mobile computing device may be configured to receive fare calculation information, among possibly other FHV-related information, from the central server. For example, the user may receive from the central server fare calculation data associated with a trip taken by the user in an FHV. The mobile computing device, or other device, may provide location information to the central server, wherein the central server is configured to perform fare calculations based on regulatory algorithms and parameters associated with the location information provided. Therefore, if the user travels from jurisdiction 1 to jurisdiction 2, as shown, and subsequently engages in an FHV transaction in jurisdiction 2, the central server may be able to identify the new location of the user and thereby determine appropriate algorithms and parameters to utilize in fare calculations associated with the FHV transaction in jurisdiction 2. Such functionality may provide users improved access to information relating to fairs and other information in jurisdictions with which they are unacquainted. A user may therefore have increased confidence in the accuracy of fare calculations presented to him or her in association with an FHV transaction.

The system may further provide improved mobility for FHV's or FHV operators. FIG. 7 illustrates an FHV initially located in jurisdiction 1. The FHV may be authorized by the relevant regulatory entity to operate under certain conditions in jurisdiction 1. In certain embodiments, the FHV may additionally have authority from the regulatory entity, or another regulatory entity, to operate in one or more additional jurisdictions or zones as well. For example, the FHV operator may be in receipt of a multi-jurisdictional or multi-zonal medallion. While operating in jurisdiction 1, the FHV may engage in transactions in which the central server performs fare calculations associated with such transactions. For example, the central server may receive locational information related to the FHV or FHV transaction and use such information to determine appropriate fare calculation algorithms and parameters. As the FHV travels to another jurisdiction, such as jurisdiction 2, as shown, the central server may be configured to recognize such change in location. The central server may then determine what regulations and/or regulatory entity are controlling in the jurisdiction or zone. As the FHV engages in transactions in jurisdiction 2, the central server may continue to provide fare calculation services, wherein such fare calculations are performed using algorithms and parameters associated with jurisdiction 2. Therefore, systems and methods disclosed herein may provide for improved convenience with respect to multi-zonal and multi-jurisdictional operation. For example, in the illustrated system, it may not be necessary for a regulatory agency to physically access taximeters in order to update operational area of an FHV or fare calculation algorithms and parameters.

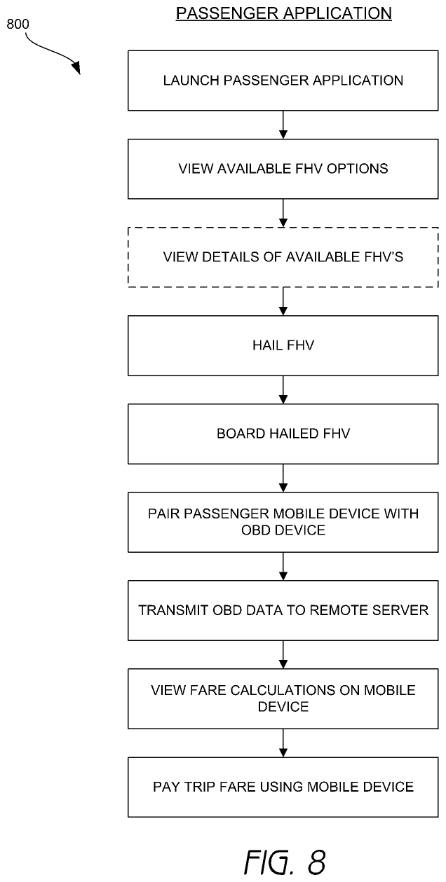

FIG. 8 is a flowchart illustrating an embodiment of a process 800 for engaging in a passenger FHV transaction. In certain embodiments, a consumer launches a software application on a mobile device. The application may present local available FHV options on a user interface. In certain embodiments, the user may View details of available FHV's by clicking or hovering over an icon representing an FHV, or by otherwise indicating a desire to view such information. Detailed information may include driver profile information or rating, vehicle specifications, fleet/company affiliation, medallion details, or other information. The user may hail an available FHV using the mobile device. For example, the user interface may provide a ‘hail’ button or other hailing functionality. In certain embodiments, the user may select a particular FHV to hail. Alternatively, the application may automatically select an FHV to hail based on FHV selection criteria, such as distance from the consumer, estimated time of arrival, user preferences, and the like.

Upon arrival of the hailed FHV, the passenger board the FHV, at which point the passenger's mobile device may be configured to pair with one or more devices disposed within the FHV. For example, the passenger's device may pair with an OBD device connected to the FHV's OBD system. In certain embodiments, the passenger's device pairs with a mobile device of the FHV operator, and communicates therewith over the paired connection. Data obtained by the passenger's mobile device from the OBD device, FHV operator's device, or independently from one or more on-board sensors (for example, GPS receiver/processor) may be transmitted by the passenger device to a remote server to be used for fare calculation. In return, the server may provide fare calculations to the passenger device for real-time viewing by the passenger. The process 800 may further include paying the calculated fare by the passenger using his or her mobile device. For example, the passenger application may include functionality for a passenger to initiate a fare payment, wherein an account of the passenger is billed for the fare, while an account of the FHV driver/owner is credited.

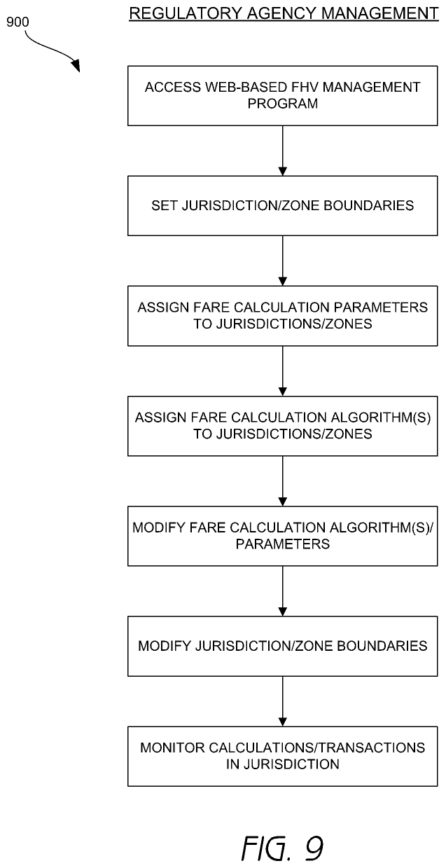

FIG. 9 is a flowchart illustrating an embodiment of a process 900 for inputting regulatory parameters by a regulatory agency. The process 900 may begin with an agent of a regulatory agency accessing a web-based FHV management program. The program may provide functionality for the regulatory agent to set jurisdiction/zone boundaries. The agent may further be able to assign fare calculation parameters and/or fare calculation algorithms to jurisdictions/zones for use in fare calculation. Algorithms/parameters, once inputted by the agent, may be utilized by a third-party entity for calculating fares for FHV trips in jurisdictions in which the regulatory agency has authority. The agency may further modify previously-inputted information, as well as jurisdiction/zone boundaries. The process 900 may further include monitoring of FHV activity within jurisdiction(s) of authority by the regulatory agency.

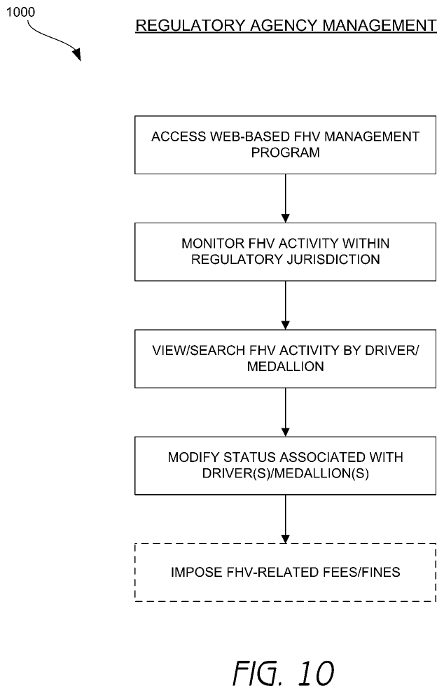

FIG. 10 is a flowchart illustrating an embodiment of a process 1000 for inputting status information by a regulatory agency. The process 1000 may begin with an agent of a regulatory agency accessing a web-based FHV management program. Using the FHV management program, the agent monitors FHV activity within regulatory jurisdiction. For example, the agent may view or search FHV activity by driver/medallion, and view associated detailed information. The agent may also modify status associated with drivers/medallions, such as by indicating that a driver is suspended, or whether a particular OBD device or medallion is enabled or disabled. Furthermore, in certain embodiments, the agent may be able to impose FHV-related fees/fines on drivers or fleet owners.

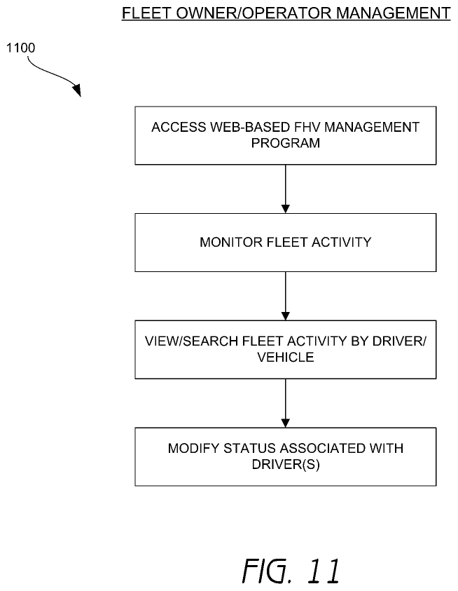

FIG. 11 is a flowchart illustrating an embodiment 1100 of a process for inputting status information by a fleet operator. The process 1100 may begin with an agent of a fleet owner/operator accessing a web-based FHV management program. The agent may monitor fleet activities using the program. For example, the agent can view/search fleet activity by driver/vehicle. The agent can further modify status associated with drivers, such as by indicating that a particular driver is suspended.

### EMBODIMENTS

The following list has example embodiments that are within the scope of this disclosure. The example embodiments that are listed should in no way be interpreted as limiting the scope of the embodiments. Various features of the example embodiments that are listed can be removed, added, or combined to form additional embodiments, which are part of this disclosure.

### Example Embodiments of for-Hire Vehicle Fare and Parameter Calculation

1. A for-hire vehicle (FHV) management system comprising:
   a computer memory that stores fare calculation information associated with a plurality of jurisdictions; and
   computer hardware including a processor in communication with the memory and configured to:
      receive trip data over a network from a computing device disposed within a remotely-located FHV indicating time and/or distance associated with a trip taken by the FHV;
      calculate a trip fare based at least in part on the trip data, the fare calculation information, and a jurisdiction within which the FHV is located; and
      provide the trip fare to the computing device disposed within the FHV over a network.
2. The system of embodiment 1, wherein the processor is further configured to store the trip data in the computer memory.
3. The system of embodiment 1, wherein the trip data includes a start time and an end time of the FHV trip.
4. The system of embodiment 1, wherein the trip data includes a distance of the FHV trip.
5. The system of embodiment 1, wherein the fare calculation information includes a plurality of fare calculation algorithms, wherein the processor is configured to select an algorithm for fare calculation based at least in part on the location of the computing device or the FHV.
6. The system of embodiment 1, wherein the fare calculation information includes a plurality of sets of fare calculation parameter values, wherein the processor is configured to select a set of parameters based at least in part on the location of the FHV.
7. A for-hire vehicle (FHV) management system comprising:
   a computer memory that stores fare calculation information associated with a plurality of regulatory jurisdictions; and
   computer hardware including a processor in communication with the memory and configured to:
      receive first trip data over a network from a first computing device disposed within a remotely located for-hire vehicle (FHV) indicating time and/or distance associated with a trip taken by the FHV;
      receive second trip data over a network from a second computing device disposed within the FHV indicating time and/or distance associated with the trip;
      calculate a trip fare based at least in part on the first trip data, the fare calculation information, and a location of the FHV;
      verify the correctness of the calculated trip fare based at least in part on the second trip data; and
      provide the trip fare to the first computing device.
8. The system of embodiment 7, wherein the processor is further configured to provide an error signal when there is a discrepancy between the first trip data and the second trip data;
9. The system of embodiment 7, wherein the processor is further configured to calculate a verification trip fare based at least in part on the second trip data, the fare calculation information, and the location of the FHV.
10. The system of embodiment 9, wherein when the trip fare and the verification trip fare are different, the processor is configured to determine an average fare of historical trips having similar starting and destination points and provide the average of the two fares to the first computing device.
11. The system of embodiment 7, wherein the second trip data includes data generated by an on-board diagnostic system of the FHV.
12. The system of embodiment 7, wherein the second trip data is received from a driver of the FHV.
13. The system of embodiment 7, wherein processor is further configured to receive third trip data from a third computing device disposed within the FHV indicating time and/or distance associated with the trip.
14. A method of calculating a for-hire vehicle (FHV) trip fare, the method comprising:
   receiving trip data from a computing device disposed within a remotely-located FHV indicating time and/or distance associated with a trip taken by the FHV;
   calculating a trip fare based at least in part on the trip data; and
   providing the trip fare to the computing device over a wide area network.
15. The method of embodiment 14, further comprising receiving trip data from a second mobile device, and verifying that the calculated trip fare is correct based at least in part on the trip data from the second mobile device.
16. The method of embodiment 14, wherein calculating the trip fare is performed using a fare calculation algorithm and fare calculation parameters stored in computer memory.
17. The method of embodiment 16, further including selecting the fare calculation algorithm from among a group of fare calculation algorithms based on a location of the computing device or the FHV.
18. The method of embodiment 17, wherein the fare calculation algorithm includes a fee associated with a geographical area when the computing device arrives at or traverses the geographical area.

### Example Embodiments of Mobile for-Hire Vehicle Hailing

1. A computer-implemented method for engaging a for-hire vehicle, the method comprising:
   by a first mobile computing device:
      receiving information from a remote server indicating FHV activity in a geographical region of interest;
      providing a user interface for viewing by a user seeking FHV transportation service, the user interface displaying a map having one or more icons thereon indicating locations of one or more FHVs;
      receiving user input indicating a desire to hail one of the one or more FHVs;
      transmitting a hailing signal;
      receiving an acceptance of the hailing signal and notifying the user of the acceptance;
      linking with a second computing device disposed within the hailed FHV over a local area network;
      providing information related to an FHV trip to the remote server;
      receiving a calculated fare; and
      displaying the calculated fare to the user.
2. The method of embodiment 1, wherein the second computing device is a mobile computing device.
3. The method of embodiment 1, wherein the calculated fare is received from the remote server.
4. The method of embodiment 1, wherein the calculated fare is based at least in part on a first set of rules when the first mobile computing device is located within a first jurisdiction and is based on a second set of rules when the first mobile computing device is located within a second jurisdiction.
5. The method of embodiment 1, wherein the user interface displays information associated with the one or more icons indicating a type of vehicle.
6. The method of embodiment 1, further including providing functionality for the user to pay the calculated fare.
7. The method of embodiment 6, wherein providing functionality for the user to pay the fare includes presenting a payment user interface, wherein the user may input payment information using the payment user interface.
8. The method of embodiment 1, wherein the user interface includes an icon indicating a current location of the user.
9. The method of embodiment 1, further comprising linking with a third mobile computing device over a local area network.
10. The method of embodiment 9, further comprising receiving a signal from the third mobile device indicating the start of the FHV trip.
11. The method of embodiment 1, further comprising displaying an estimated time of arrival of the hailed FHV.
12. The method of embodiment 1, further comprising displaying a distance of the hailed FHV from a current location of the user or a designated pick-up location.
13. The method of embodiment 1, further comprising providing functionality for the user to select an FHV for hailing from among a group of available FHVs.
14. A system for managing calculated fares associated with for-hire vehicle activity, the system comprising:
   a computer memory; and
   computer hardware including a processor in communication with the memory and configured to:
      receive information from a remote server indicating FHV activity in a geographical region of interest;
      provide a user interface for viewing by a user seeking FHV transportation service, the user interface displaying a map having one or more icons thereon indicating locations of one or more FHVs;
      receive user input indicating a desire to hail one of the one or more FHVs;
      transmit a hailing signal;
      receive an acceptance of the hailing signal and notify the user of the acceptance;
      link with a second mobile computing device disposed within the hailed FHV over a local area network;
      provide information related to an FHV trip to the remote server;
      receive a calculated fare; and
      display the calculated fare to the user.
15. The system of embodiment 14, wherein the user interface is configured to display information associated with the one or more icons indicating a type of vehicle.
16. The system of embodiment 14, wherein the processor is further configured to provide functionality for the user to pay the calculated fare.
17. The system of embodiment 16, wherein the processor is configured to present a payment user interface to the user, wherein the user may input payment information using the payment user interface.
18. The system of embodiment 14, wherein the user interface includes an icon indicating a current location of the user.
19. The system of embodiment 14, wherein the processor is further configured to link with a third mobile computing device over a local area network.
20. The system of embodiment 19, wherein the processor is further configured to receive a signal from the third mobile device indicating the start of the FHV trip.
21. The system of embodiment 14, wherein the processor is further configured to display an estimated time of arrival of the hailed FHV.
22. The system of embodiment 14, wherein the processor is further configured to display a distance of the hailed FHV from a current location of the user or a designated pick up location.
23. The system of embodiment 14, wherein the processor is further configured to provide functionality for the user to select an FHV for hailing from among a group of available FHVs.

### Example Embodiments of for-Hire Vehicle Parameter Update and Management

1. A system for managing fare calculations associated with for-hire vehicle activity, the system comprising:
   a computer memory that stores fare calculation information associated with a plurality of jurisdictions regulated by one or more regulatory entities;
   computer hardware including one or more processors in communication with the memory and configured to:
      provide a user interface for viewing by an agent of the regulatory entity, the user interface including functionality for a user to input updated fare calculation information;
      receive updated fare calculation information from a first remote computer, the updated fare calculation information input using the user interface;
      store the updated fare calculation parameter information in the memory; and
      wherein the computer memory stores fare calculation information associated with the plurality of jurisdictions each of which is regulated by a different regulatory entity.
2. The system of embodiment 1, wherein the computer hardware is further configured to calculate trip fares based at least partially on the updated fare calculation parameter information and trip distance and/or time information provided by a second remote computer.
3. The system of embodiment 2, wherein the one or more processors are further configured to calculate trip fares based at least partially on the fare calculation information associated with the jurisdictions regulated by each regulatory entity.
4. The system of embodiment 1, wherein the user interface is configured to display a map showing real-time FHV activity in at least a portion of the jurisdiction.
5. The system of embodiment 4, wherein the user interface is further configured to display historical FHV activity.
6. The system of embodiment 1, wherein the user interface is configured to display a list of FHV trips taken within the jurisdiction, as well as details associated with the trips.
7. The system of embodiment 1, wherein the fare calculation information includes an algorithm, wherein the processors are configured to calculate trip fares using the algorithm.
8. The system of embodiment 1, wherein the fare calculation information includes fare calculation algorithm parameter values, wherein the processors are configured to calculate trip fares using the parameter values.
9. The system of embodiment 1, wherein the user interface is configured to display a list of drivers who have been authorized to operate in the jurisdiction.
10. The system of embodiment 1, wherein the user interface provides functionality for the user to search for specific trips and/or drivers associated with the jurisdiction.
11. The system of embodiment 1, wherein the user interface provides functionality for the user to modify a status of a driver to indicate that a license to operate of the driver is enabled or disabled.
12. The system of embodiment 1, wherein the user interface provides functionality for the user to indicate that a driver is suspended by the regulatory entity.
13. A method of managing for-hire vehicle (FHV) fare calculations, the method comprising:
   maintaining fare calculation information associated with a plurality of jurisdictions regulated by FHV regulatory entities in computer memory;
   providing a user interface for viewing by an agent of an FHV regulatory entity, the user interface including functionality for a user to input updated fare calculation information;
   receiving updated fare calculation information from a first remote computer, the updated fare calculation information input using the user interface;
   storing the updated fare calculation parameter information in the memory; and
   storing fare calculation information associated with a jurisdiction regulated by a second regulatory entity in the computer memory.
14. The method of embodiment 13, further comprising calculating trip fares based at least partially on the updated fare calculation parameter information and trip distance and/or time information provided by a second remote computer.
15. The method of embodiment 14, further comprising calculating trip fares based at least partially on the fare calculation information associated with each jurisdiction regulated by the regulatory entities.
16. The method of embodiment 13, wherein the user interface is configured to display a map showing real-time FHV activity in at least a portion of the jurisdiction.
17. The method of embodiment 16, wherein the user interface is further configured to display historical FHV activity.
18. The method of embodiment 13, wherein the user interface is configured to display a list of FHV trips taken within the jurisdiction, as well as details associated with the trips.
19. The method of embodiment 13, wherein the fare calculation information includes an algorithm, wherein the processors are configured to calculate trip fares using the algorithm.
20. The method of embodiment 13, wherein the fare calculation information includes fare calculation algorithm parameter values, wherein the processors are configured to calculate trip fares using the parameter values.

### Example Embodiments of an On-Board Diagnostic Device

1. An on-board vehicle diagnostics device comprising:
   a housing;
   an on-board diagnostics (OBD) engagement member configured to physically engage with an OBD port of a for-hire vehicle (FHV) and receive power and data communications therefrom; and
   computer circuitry disposed at least partially within the housing configured to receive time, location, and/or distance information associated with a trip taken by the vehicle, the information being received through the OBD port of the vehicle;
   wherein the computer circuitry is further configured to wirelessly communicate with one or more computing devices disposed within the FHV over a local area network when the on-board diagnostics device is connected to the OBD port.
2. The device of embodiment 1, further comprising a GPS receiver.
3. The device of embodiment 2, wherein the GPS receiver is electrically coupled to an antenna external to the device.
4. The device of embodiment 1, further comprising an OBD signal pass-through connection port.
5. The device of embodiment 4, wherein the pass-through port is a 16-pin female connection port.
6. The device of embodiment 4, wherein the pass-through port is configured to allow for a dedicated taximeter device to be plugged into the port.
7. The device of embodiment 4, wherein the pass-through port provides identical signals as are provided by the OBD port of the FHV.
8. The device of embodiment 4, wherein the pass-through port supports additional signals to synchronize with start/stop buttons of a dedicated taximeter.
9. The device of embodiment 1, wherein the computer circuitry is configured to communicate with the one or more external computing devices over a BLUETOOTH connection.
10. The device of embodiment 1, wherein the computer circuitry is configured to communicate with the one or more external computing devices over a Wi-Fi connection.
11. The device of embodiment 1, wherein the computer circuitry is configured to transmit odometer information to the one or more external computing devices.
12. The device of embodiment 1, wherein the one or more external computing devices are smartphones.
13. The device of embodiment 1, further comprising an electrical cord connecting the OBD engagement member to the housing.
14. The device of embodiment 1, wherein the computer circuitry is configured to wirelessly communicate with the one or more computing devices automatically.
15. A computer-implemented method of communicating vehicle diagnostics information, the method comprising:
   receiving odometer, time, and/or location information from an on-board diagnostics (OBD) system of an FHV over a wired connection;
   communicatively linking wirelessly with a mobile computing device disposed within the FHV; and
   transmitting the odometer, time, and/or location information over the wireless link while the FHV is in transit.
16. The method of embodiment 14, further comprising receiving a GPS signal using a GPS receiver that is not part of the FHV's OBD system.
17. The method of embodiment 14, further comprising providing pass-through OBD signals to a directed taximeter device disposed within the FHV over a wired connection.
18. The method of embodiment 16, wherein the pass-through OBD signals are provided over a 16-pin female connection port.
19. The method of embodiment 14, wherein linking with the mobile computing device comprises pairing with the mobile computing device over a BLUETOOTH connection.
20. The method of embodiment 14, wherein said receiving, linking, and transmitting are performed automatically.
21. The method of embodiment 14, further comprising communicatively linking wirelessly with a passenger mobile device.
22. An on-board vehicle diagnostics device comprising:
   a housing;
   an on-board diagnostics (OBD) engagement member configured to physically engage with an OBD port of a for-hire vehicle (FHV) and receive power and data communications therefrom; and
   computer circuitry disposed at least partially within the housing configured to receive GPS information associated with a trip taken by the vehicle, the information being received through the OBD port of the vehicle;
23. The method of embodiment 22, wherein the computer circuitry is further configured to wirelessly communicate with one or more computing devices disposed within the FHV over a local area network when the on-board diagnostics device is connected to the OBD port.
24. An on-board vehicle location device comprising:
   a housing physically coupled to a component of a for-hire vehicle (FHV);
   a GPS receiver;
   computer circuitry disposed at least partially within the housing configured to wirelessly communicate with one or more computing devices disposed within the FHV over a local area network when the FHV is in operation.

### Example Embodiments of Transportation Control and Regulation

1. A for-hire vehicle (FHV) vehicle dispatch, fare calculation and medallion monitoring system comprising:
   a server including a computer memory and a processor for calculating FHV trip fares, wherein the computer memory is configured to store at least the following information provided by a regulatory entity:
      one or more fare calculation algorithms;
      fare calculation parameters;
      valid medallions granted by the regulatory entity;
      geographical boundaries associated with a set of fare calculation algorithms and parameters; and
      at least one dispatcher approved to operate within a jurisdiction of the regulatory entity;
   a FHV mobile device communicatively coupled to an on-board diagnostics (OBD) system of an FHV, the FHV having a valid medallion, and identification of the medallion stored in the computer memory, the FHV mobile device being configured to transmit location, time and/or distance information from the OBD system to the server; and
   a customer mobile device configured to transmit a request for transportation service to the server, wherein the server forwards a corresponding dispatch request to a approved dispatcher;
   wherein the server is configured to calculate an FHV trip fare based at least in part on the location, time and/or distance information and the information provided by the regulatory entity; and wherein the server is configured to provide access to information stored in the computer memory associated with the regulatory entity's jurisdiction to the regulatory entity.
2. The system of embodiment 1, further comprising a dedicated taximeter disposed within the FHV, wherein the taximeter is configured to operate independently of the server based on information from the FHV's OBD system.
3. The system of embodiment 1, wherein the approved dispatcher is part of the server.
4. The system of embodiment 1, wherein the approved dispatcher is separate from the server.
5. The system of embodiment 1, wherein the approved dispatcher automatically dispatches an FHV to a designated pick-up location in response to receiving the request from the server.
6. The system of embodiment 1, further comprising a fleet operator entity, wherein the server provides information relating to a fleet of FHVs controlled by the fleet operator.
7. A method of managing for-hire vehicle (FHV) vehicle dispatch, fare calculation and medallion operations, the method comprising:
   receiving the following information from a regulatory entity:
      one or more fare calculation algorithms;
      fare calculation parameters;
      valid medallions granted by the regulatory entity;
      one or more geographical boundaries defining a jurisdiction of the regulatory entity and/or associated zones; and
      at least one dispatcher permitted to operate within a jurisdiction of the regulatory entity;
   storing the information from the regulatory entity in computer storage;
   receiving location, time and/or distance information from a mobile device communicatively coupled to an on-board diagnostics (OBD) system of an FHV, the FHV being associated with a valid medallion stored in the computer storage;
   receiving a request for transportation service from a customer mobile device;
   providing a corresponding dispatch request to a permitted dispatcher; and
   calculating an FHV trip fare based at least in part on the location, time and/or distance information and the information from the regulatory entity.
8. The method of embodiment 7, further comprising operating a dedicated taximeter disposed within the FHV.
9. The method of embodiment 7, wherein the permitted dispatcher is remotely located.
10 The method of embodiment 7, automatically dispatching, by the permitted dispatcher, an FHV, based on the request for transportation.
11. The method of embodiment 7, further comprising providing information to a fleet operator entity relating to a fleet of FHVs controlled by the fleet operator.
12. A method of managing multi-jurisdictional for-hire vehicle (FHV) activity, the method comprising:
   receiving registration information from a user;
   determining that the user is located within a first jurisdiction;
   servicing a first FHV transaction of the user using first trip-related information when the user is located within the first jurisdiction;
   determine that the user is located within a second jurisdiction; and
   servicing a second FHV transaction of the user using second trip-related information when the user is located within the second jurisdiction.
13. The method of embodiment 12, further comprising receiving first regulation data from a first regulatory entity and receiving second regulation data from a second regulatory entity, wherein the first trip-related information includes the first regulation data and the second trip-related information includes the second regulation data.
14. The method of embodiment 12, further comprising receiving regulation data from a regulatory entity, wherein the first trip-related information and the second trip-related information include the regulation data.
15. The method of embodiment 12, further comprising providing a software application to the user, wherein the user initiates the first FHV transaction using the software application.
16. The method of embodiment 12, wherein the first and second trip-related information includes fare calculation parameter and algorithm information.
17. The method of embodiment 12, wherein the first and second trip-related information includes geographical zone and/or jurisdiction boundary information.
18. The method of embodiment 12, wherein the first trip-related information includes taxi company information associated with the first FHV transaction.
19. The method of embodiment 12, wherein the second trip-related information includes taxi company information associated with the second FHV transaction.
20. A multi-jurisdictional for-hire vehicle (FHV) management system comprising:
   a computer memory; and
   computer hardware including a processor in communication with the memory and configured to:
      receive registration information from a user;
      store the registration information in the computer memory;
      determine that the user is located in a first jurisdiction;
      service a first FHV transaction of the user using first trip-related information when the user is located within the first jurisdiction;
      determine that the user is located in a second jurisdiction; and
      service a second FHV transaction of the user using second trip-related information when the user is located within the second jurisdiction.
21. The system of embodiment 20, wherein the processor is further configured to receive first regulation data from a first regulatory entity and receive second regulation data from a second regulatory entity, wherein the first trip-related information includes the first regulation data and the second trip-related information includes the second regulation data.
22. The system of embodiment 20, wherein the processor is further configured to receive regulation data from a regulatory entity, wherein the first trip-related information and the second trip-related information include the regulation data.
23. The system of embodiment 20, wherein the processor is further configured to provide a software application to the user, wherein the first FHV transaction is initiated by the user using the software application.
24. The system of embodiment 20, wherein the first and second trip-related information includes fare calculation parameter and algorithm information.
25. The system of embodiment 20, wherein the first and second trip-related information includes geographical zone and/or jurisdiction boundary information.
26. The system of embodiment 20, wherein the first trip-related information includes taxi company information associated with the first FHV transaction.
27. The system of embodiment 20, wherein the second trip-related information includes taxi company information associated with the second FHV transaction.
28. A computer-implemented method of optimizing for-hire vehicle (FHV) activity, the method comprising:
   collecting FHV activity data indicating real-time positions of a plurality or FHVs in a first jurisdiction;
   receiving a request for transportation services from a consumer;
   calculating estimated distance and/or travel time between a designated pick-up location and each of the plurality of FHVs; and
   automatically dispatching an FHV of the plurality of FHVs based at least in part on the calculated distance and/or travel time.
29. The method of embodiment 28, wherein at least one of the plurality of FHVs is owned and operated by a first entity and at least one of the plurality of FHVs is owned and operated by a second entity.
30. The method of embodiment 28, wherein at least one of the plurality of FHVs is located within a first regulatory jurisdiction and at least one of the plurality of FHVs is located within a second regulatory jurisdiction.
31. The method of embodiment 28, wherein automatically dispatching the FHV comprises dispatching an FHV to pick up the consumer at a location in a first geographical jurisdiction from a second geographical jurisdiction in order to meet demands of the first geographical jurisdiction.

### Terminology

Many other variations than those described herein will be apparent from this disclosure. For example, depending on the embodiment, certain acts, events, or functions of any of the algorithms described herein can be performed in a different sequence, can be added, merged, or left out all together (e.g., not all described acts or events are necessary for the practice of the algorithms). Moreover, in certain embodiments, acts or events can be performed concurrently, e.g., through multi-threaded processing, interrupt processing, or multiple processors or processor cores or on other parallel architectures, rather than sequentially. In addition, different tasks or processes can be performed by different machines and/or computing systems that can function together.

The various illustrative logical blocks, modules, and algorithm steps described in connection with the embodiments disclosed herein can be implemented as electronic hardware, computer software, or combinations of both. To clearly illustrate this interchangeability of hardware and software, various illustrative components, blocks, modules, and steps have been described above generally in terms of their functionality. Whether such functionality is implemented as hardware or software depends upon the particular application and design constraints imposed on the overall system. The described functionality can be implemented in varying ways for each particular application, but such implementation decisions should not be interpreted as causing a departure from the scope of the disclosure. Further, the headings used herein should not be used to limit the scope of the claims, as they merely illustrate example embodiments.

The various illustrative logical blocks and modules described in connection with the embodiments disclosed herein can be implemented or performed by a machine, such as a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor can be a microprocessor, but in the alternative, the processor can be a controller, microcontroller, or state machine, combinations of the same, or the like. A processor can also be implemented as a combination of computing devices, e.g., a combination of a DSP and a microprocessor, a plurality of microprocessors, one or more microprocessors in conjunction with a DSP core, or any other such configuration. Although described herein primarily with respect to digital technology, a processor may also include primarily analog components. For example, any of the signal processing algorithms described herein may be implemented in analog circuitry. A computing environment can include any type of computer system, including, but not limited to, a computer system based on a microprocessor, a mainframe computer, a digital signal processor, a portable computing device, a personal organizer, a device controller, and a computational engine within an appliance, to name a few.

The steps of a method, process, or algorithm described in connection with the embodiments disclosed herein can be embodied directly in physical computer hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of non-transitory computer-readable storage medium, media, or physical computer storage known in the art. An exemplary storage medium can be coupled to the processor such that the processor can read information from, and write information to, the storage medium. In the alternative, the storage medium can be integral to the processor. The processor and the storage medium can reside in an ASIC. The ASIC can reside in a user terminal. In the alternative, the processor and the storage medium can reside as discrete components in a user terminal.

Conditional language used herein, such as, among others, “can,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

While the above detailed description has shown, described, and pointed out novel features as applied to various embodiments, it will be understood that various omissions, substitutions, and changes in the form and details of the devices or algorithms illustrated can be made without departing from the spirit of the disclosure. As will be recognized, certain embodiments of the inventions described herein can be embodied within a form that does not provide all of the features and benefits set forth herein, as some features can be used or practiced separately from others.

What is claimed is:

1. A method comprising:
a for-hire vehicle (“FHV”) management server communicating over a network with a FHV operator mobile device having an operator application disposed thereon;
the operator application providing functionality for communicating with the FHV management server over the network;
detecting a location of an FHV operator using global positioning system (“GPS”) coordinates;
the FHV management server communicating over the network with a passenger mobile device having a passenger application disposed thereon;
the passenger application providing functionality for communicating with the FHV management server over the network;
the passenger mobile device detecting a location of a user using GPS;
transmitting GPS coordinates to the FHV management server;
the FHV management server configured to calculate a fare;
the FHV management server communicating the calculated fare to the passenger mobile device;
the passenger application displaying, on the passenger mobile device, the calculated fare and a map showing a plurality of for-hire vehicles as icons on the map;
the passenger mobile device displaying information indicating a type of vehicle;
the passenger mobile device displaying vehicle capacity to the user;
a user interface of the FHV operator mobile device configured to enable the FHV operator to accept a request for transportation services;
the passenger mobile device displaying a driver rating to the user;
allowing the user to hail a vehicle using the passenger mobile device comprising:
the passenger mobile device receiving an input from the user indicating a desire to hail one of the plurality of for-hire vehicles;
transmitting a hailing signal;
receiving an acceptance of the hailing signal; and
notifying the user of acceptance; and
automatically selecting a FHV to hail based on one or more preferences of the user.

2. The method of claim 1 wherein the method does not use a FHV meter.

3. The method of claim 1 further comprising displaying an estimated time of arrival of the selected FHV.

4. The method of claim 1 further comprising displaying a distance of the selected FHV from a current location of the user or from a designated pick-up location.

5. The method of claim 1 wherein the FHV management server comprises a fare calculation engine which performs a fare calculation that is based at least in part on time and distance.

6. The method of claim 5 wherein time comprises trip duration time.

7. The method of claim 6 wherein trip duration time is determined from time of pickup of the user and time of drop off of the user.

8. The method of claim 1 wherein the for-hire vehicle operator mobile device comprises a smartphone.

9. The method of claim 1 wherein the FHV operator mobile device is configured to communicate with an onboard diagnostic device of the selected FHV.

10. The method of claim 1 wherein the passenger mobile device is configured to pair with one or more devices disposed within the selected FHV upon arrival.

11. The method of claim 10 wherein the one or more devices comprise an onboard diagnostic device.

12. The method of claim 1 further comprising an algorithm selector module configured to select a fare calculation algorithm from a plurality of fare calculation algorithms.

13. The method of claim 12 wherein the plurality of fare calculation algorithms comprises a first fare calculation algorithm for a first geographical jurisdiction zone and a second fare calculation algorithm for a second geographical jurisdiction zone.

14. The method of claim 1 further comprising selecting from one or more parameters for use in a fare calculation algorithm with a parameter selector module.

15. A method comprising:
a for-hire vehicle management server communicating over a network with a for-hire vehicle operator mobile device having an operator application disposed thereon for an operator of a for-hire vehicle (“FHV”);
the operator application providing functionality for communicating with the FHV management server over the network;
detecting a location of the operator of the FHV using global positioning system (“GPS”) coordinates;
the FHV management server communicating over the network with a passenger mobile device having a passenger application disposed thereon;
the passenger application providing functionality for communicating with the FHV management server over the network;
the passenger mobile device detecting a location of a user using GPS;
transmitting GPS coordinates to the FHV management server;
the FHV management server communicating a plurality of calculated fares to the passenger mobile device;
allowing a user to view a plurality of for-hire vehicles as icons on a map, as well as the plurality of calculated fares on the mobile device;
the passenger mobile device displaying information indicating a type of vehicle;
the passenger mobile device displaying vehicle capacity to the user;
the passenger mobile device receiving an input from the user indicating a desire to hail a FHV;
the passenger mobile device transmitting a hailing signal;
automatically selecting an FHV to hail based on one or more preferences of the user;
a user interface of the FHV operator mobile device configured to enable the operator of the FHV to accept a request for transportation services;
the passenger mobile device displaying a driver rating to the user; and
the passenger mobile device receiving an acceptance of the hailing signal.

16. The method of claim 15 wherein the method does not use a FHV meter.

17. The method of claim 15 further comprising displaying an estimated time of arrival of the selected FHV.

18. The method of claim 15 further comprising displaying a distance of the selected FHV from a current location of the user or from a designated pick-up location.

19. The method of claim 15 wherein the FHV operator mobile device comprises a smartphone.

20. The method of claim 15 wherein the passenger mobile device is configured to pair with one or more devices disposed within the selected FHV upon arrival.
